(19) United States
(12) Patent Application Publication
(10) Pub. No.: US 2026/0352988 A1
(43) Pub. Date: Nov. 5, 2026

(54) MEMS MICROPHONE, PREPARION METHOD THEREFOR, AND ELECTRONIC DEVICE

(71) Applicant: Honor Device Co., Ltd., Shenzhen (CN)

(72) Inventors: Ziyou Yang, Shenzhen (CN); Liying Wang, Shenzhen (CN); Bing Wang, Shenzhen (CN)

(21) Appl. No.: 19/114,693

(22) PCT Filed: Aug. 14, 2024
(86) PCT No.: PCT/CN2024/111930

§ 371 Date: Mar. 24, 2025

(30) Foreign Application Priority Data
Nov. 28, 2023 (CN) 202311602168.5

(51) Int. Cl. H04R 1/04; H04R 1/06; H04R 19/04; H04R 31/00

(52) U.S. Cl. CPC H04R 1/04; H04R 1/06; H04R 19/04; H04R 31/003; H04R 2201/003; H04R 2499/11

(57) ABSTRACT

This application provides a MEMS microphone, a preparation method therefor. The MEMS microphone includes a circuit board, a MEMS chip, and an ASIC chip, where the circuit board is provided with a sound hole, the sound hole runs through the circuit board in a thickness direction of the circuit board, the MEMS chip is mounted on the circuit board, covers the sound hole, and is electrically connected to the circuit board, a sound cavity of the MEMS chip is in communication with the sound hole, and the ASIC chip is mounted on a side surface of the MEMS chip and is electrically connected to both the MEMS chip and the circuit board.

### CROSS-REFERENCED TO RELATED MATTERS

This application is a national stage of International Application No. PCT/CN2024/111930, filed on Aug. 14, 2024, which claims priority to Chinese Patent Application No. 202311602168.5, filed on Nov. 28, 2023. The disclosures of both of the aforementioned applications are hereby incorporated by reference in their entireties.

### TECHNICAL FIELD

This application relates to the field of acoustic-electric conversion technologies, and in particular, to a MEMS microphone, a preparation method therefor, and an electronic device.

### BACKGROUND

Micro-electro-mechanical systems (Micro-Electro-Mechanical Systems, MEMS) microphones are widely used in various electronic devices due to advantages such as a high signal-to-noise ratio, good stability, and low power consumption. In a conventional MEMS microphone, a MEMS chip and an application specific integrated circuit (Application Specific Integrated Circuit, ASIC) chip can cooperate to convert a sound signal into an electrical signal, so that the MEMS microphone implements a sound receiving function. However, the layout of positions of the MEMS chip and the ASIC chip in conventional technologies is improper, resulting in a large overall volume of the MEMS microphone. This makes it difficult to achieve a miniaturized design of the MEMS microphone, and is not conducive to achieving a light and thin design of an electronic device.

### SUMMARY

This application provides a MEMS microphone, a preparation method therefor, and an electronic device, which can reduce an overall volume of the MEMS microphone, and facilitate a miniaturized design of the MEMS microphone, thereby helping achieve a light and thin design of the electronic device.

According to a first aspect, this application provides a MEMS microphone, including a circuit board, a MEMS chip, and an ASIC chip, where the circuit board is provided with a sound hole, the sound hole runs through the circuit board in a thickness direction of the circuit board, the MEMS chip is mounted on the circuit board, covers the sound hole, and is electrically connected to the circuit board, a sound cavity of the MEMS chip is in communication with the sound hole, and the ASIC chip is mounted on a side surface of the MEMS chip and is electrically connected to both the MEMS chip and the circuit board. According to the MEMS microphone provided in this application, the ASIC chip is fixedly mounted on the side surface of the MEMS chip, so that a structure obtained after the MEMS chip and the ASIC chip are assembled can be more compact, and mounting space occupied by the MEMS chip and the ASIC chip in the MEMS microphone can be reduced, thereby helping reduce an overall volume of the MEMS microphone, and facilitating a miniaturized design of the MEMS microphone. In addition, a mounting area occupied by the MEMS chip and the ASIC chip on the circuit board is reduced, so that materials required for manufacturing the circuit board and a housing can be reduced, and production costs of the MEMS microphone can be reduced.

In a possible implementation, the ASIC chip includes a chip body and an active layer, where the active layer and the chip body are stacked on the side surface of the MEMS chip, so that the ASIC chip can be vertically mounted on the side surface of the MEMS chip.

In a possible implementation, the MEMS chip includes a back plate, a support frame, a first support layer, a diaphragm, and a second support layer, where the back plate is fixedly connected to a side of the support frame facing away from the circuit board, the first support layer is arranged on a surface of the back plate facing away from the support frame, the diaphragm is arranged on a surface of the first support layer facing away from the back plate, and the second support layer is arranged on a surface of the support frame facing away from the back plate; and the active layer and the chip body are stacked on an outer peripheral surface of the support frame. In this arrangement, the diaphragm is spaced apart from the back plate by the first support layer, so that the diaphragm and the back plate jointly form a capacitor structure. When the diaphragm is subjected to a sound pressure of a sound signal, the diaphragm is deformed, and a capacitance value between the diaphragm and the back plate changes. The ASIC chip can detect a capacitance change between the diaphragm and the back plate, and convert the capacitance change into an electrical signal for outputting, so that acoustic-electric conversion is completed, and the MEMS microphone implements a sound receiving function.

In a possible implementation, the first support layer is further arranged on a surface of the ASIC chip facing away from the circuit board, and the diaphragm is further arranged on a surface of the first support layer facing away from the ASIC chip. In this arrangement, the ASIC chip may support the diaphragm, and an effective area of the diaphragm significantly increases, thereby speeding up a response speed of the diaphragm to the sound signal, and reducing an acoustic conversion loss ratio of the diaphragm, so that acoustic efficiency of the MEMS microphone can be improved, and acoustic performance of the MEMS microphone can be improved.

In a possible implementation, the MEMS chip further includes a first wiring layer, a second wiring layer, and a third wiring layer, where both the first wiring layer and the second wiring layer are arranged on a side of the back plate facing away from the support frame, the first wiring layer is electrically connected between the back plate and the ASIC chip, the second wiring layer is spaced apart from the first wiring layer and is electrically connected between the diaphragm and the ASIC chip, and the third wiring layer is arranged on a side of the support frame facing the circuit board and is electrically connected between the ASIC chip and the circuit board. In this embodiment, the first wiring layer and the second wiring layer are arranged, so that the diaphragm and the back plate each can be electrically connected to the ASIC chip, and the ASIC chip can detect the capacitance change between the diaphragm and the back plate, so that conversion between the sound signal and the electrical signal can be implemented, so that the sound receiving function of the MEMS microphone can be implemented. The third wiring layer is arranged, and an end of the third wiring layer away from the ASIC chip is electrically connected to the circuit board, so that the ASIC chip is electrically connected to the circuit board, so that the MEMS chip can be electrically connected to the circuit board through the ASIC chip.

In a possible implementation, the MEMS microphone further includes a connecting layer, where the connecting layer is connected between the outer peripheral surface of the support frame and the ASIC chip. The connecting layer is formed between the outer peripheral surface of the support frame and the ASIC chip, so that the MEMS chip can be electrically connected to the ASIC chip.

In a possible implementation, the connecting layer is a wafer bonding layer, and is electrically connected to the first wiring layer, the second wiring layer, the third wiring layer, and the active layer. In this embodiment, the wafer bonding layer is formed by using a wafer bonding process, so that the first wiring layer, the second wiring layer, and the third wiring layer are electrically connected to the active layer through the wafer bonding layer. In this arrangement, a signal transmission distance between the ASIC chip and the MEMS chip is shortened, thereby helping increase a signal transmission speed between the MEMS chip and the ASIC chip. In addition, the electrical connection between the MEMS chip and the ASIC chip does not need to be implemented by using a gold wire required for wire bonding, thereby also helping reduce the production costs of the MEMS microphone.

In a possible implementation, the connecting layer is a solder layer, the connecting layer includes a first solder portion, a second solder portion, and a third solder portion, the first solder portion is electrically connected between the first wiring layer and the active layer, the second solder portion is spaced apart from the first solder portion and is electrically connected between the second wiring layer and the active layer, and the third solder portion is located on a side of the first solder portion and the second solder portion facing the circuit board, is spaced apart from both the first solder portion and the second solder portion, and is electrically connected between the third wiring layer and the active layer. In this arrangement, reliability of the connection between the MEMS chip and the ASIC chip can be enhanced, and fixing between the MEMS chip and the ASIC chip can also be implemented by using a soldering process. In this way, costs are low, which helps reduce the production costs of the MEMS microphone.

In a possible implementation, the connecting layer is an anisotropic conductive film, where the anisotropic conductive film includes a first conductive part and a second conductive part, the first conductive part is electrically connected between the first wiring layer, the second wiring layer, and the active layer, the second conductive part is located on a side of the first conductive part facing the circuit board, and the second conductive part is electrically connected between the third wiring layer and the active layer. In this arrangement, the anisotropic conductive film is directly attached between the MEMS chip and the ASIC chip, so that the MEMS chip can be electrically connected to the ASIC chip. In this way, the operation is simple, which helps improve production efficiency of the MEMS microphone.

In a possible implementation, the chip body and the active layer are sequentially stacked on a surface of the connecting layer facing away from the support frame. For example, the ASIC chip further includes a fourth wiring layer, a fifth wiring layer, and a sixth wiring layer, where the fourth wiring layer is electrically connected between the active layer and the first wiring layer, the fifth wiring layer is spaced apart from the fourth wiring layer and is electrically connected between the active layer and the second wiring layer, and the sixth wiring layer is located on a side of the fourth wiring layer and the fifth wiring layer facing the circuit board, is spaced apart from both the fourth wiring layer and the fifth wiring layer, and is electrically connected between the active layer and the third wiring layer. In this arrangement, wires between the ASIC chip and the MEMS chip are all arranged inside the chips, so that the signal transmission distance between the ASIC chip and the MEMS chip is shortened, thereby helping increase the signal transmission speed between the MEMS chip and the ASIC chip. In addition, the electrical connection between the MEMS chip and the ASIC chip does not need to be implemented by using a gold wire required for wire bonding, thereby also helping reduce the production costs of the MEMS microphone.

In a possible implementation, the connecting layer is a die attach film, where the die attach film is attached between the support frame and the chip body; and the MEMS microphone further includes a first wire, a second wire, and a third wire, where the first wire is electrically connected between the first wiring layer and the active layer, the second wire is electrically connected between the second wiring layer and the active layer, and the third wire is electrically connected between the third wiring layer and the active layer. In this arrangement, the electrical connection between the MEMS chip and the ASIC chip and the electrical connection between the ASIC chip and the circuit board are implemented through wire bonding, so that the reliability of the connection between the produced MEMS chip and the ASIC chip is relatively good. In addition, costs of the wire bonding process are lower than those of the wafer bonding process, which also helps reduce the production costs of the MEMS microphone. In addition, there is no need to additionally arrange a wiring layer inside the ASIC chip, which helps simplify a production process of the MEMS microphone and improve the production efficiency of the MEMS microphone.

In a possible implementation, the active layer and the chip body are sequentially stacked on a surface of the connecting layer facing away from the support frame. For example, a flip chip manner is used, so that the active layer of the ASIC chip can be electrically connected to the MEMS chip through the solder layer. In this case, there is no need to additionally arrange a wire inside the ASIC chip, which can simplify a production process of the MEMS microphone, and helps improve the production efficiency of the MEMS microphone.

In a possible implementation, the back plate is provided with a plurality of through holes, where the plurality of through holes run through the back plate in a thickness direction of the back plate, are arranged at intervals from each other, and are all in communication with the sound cavity of the MEMS. In this way, a sound signal of an external environment can enter the MEMS chip.

In a possible implementation, the MEMS microphone further includes a housing, where the housing is fixedly mounted on the circuit board, and covers the MEMS chip and the ASIC chip. For example, the housing is made of a metal material. The housing may protect the MEMS chip and the ASIC chip, and can prevent another electromagnetic signal from interfering with normal use of the MEMS chip and the ASIC chip.

According to a second aspect, this application further provides an electronic device, including a processor and the foregoing MEMS microphone, where the processor is electrically connected to the MEMS microphone. According to the electronic device provided in this application, the foregoing MEMS microphone is arranged, which helps achieve a light and thin design of the electronic device.

According to a third aspect, this application further provides a method for preparing a MEMS microphone, including: providing a microphone intermediate body and a circuit board, where the microphone intermediate body includes a silicon substrate and an ASIC chip, the silicon substrate includes a support frame intermediate body and a back plate, the back plate is fixedly connected to an upper surface of the support frame intermediate body, the ASIC chip is mounted on a side surface of the silicon substrate and is electrically connected to the back plate, the circuit board is provided with a sound hole, and the sound hole runs through the circuit board in a thickness direction of the circuit board; forming a first sacrificial layer on an upper surface of the silicon substrate and an upper surface of the ASIC chip; forming a diaphragm on a surface of the first sacrificial layer facing away from the silicon substrate and the ASIC chip, where the diaphragm is electrically connected to the ASIC chip; forming a second sacrificial layer on a lower surface of the silicon substrate and a lower surface of the ASIC chip; etching the second sacrificial layer, the silicon substrate, and the first sacrificial layer in a direction from the lower surface of the silicon substrate to the upper surface of the silicon substrate, to form a second support layer, a support frame, and a first support layer, to obtain a MEMS chip; and mounting the MEMS chip and the ASIC chip on the circuit board, to obtain a MEMS microphone, where the MEMS chip covers the sound hole and is electrically connected to the circuit board, a sound cavity of the MEMS chip is in communication with the sound hole, and the ASIC chip is electrically connected to the circuit board. According to the method for preparing a MEMS microphone provided in this embodiment, the ASIC chip is fixedly mounted on a side surface of the MEMS chip by using a wafer bonding process, so that a structure obtained after the MEMS chip and the ASIC chip are assembled can be more compact, and mounting space of the MEMS chip and the ASIC chip in the MEMS microphone can be reduced, thereby helping reduce an overall volume of the MEMS microphone, and facilitating a miniaturized design of the MEMS microphone, thereby helping achieve a light and thin design of an electronic device. In addition, a mounting area occupied by the MEMS chip and the ASIC chip on the circuit board is reduced, and an area of the circuit board used in the MEMS microphone provided in this application is reduced by 50% compared with an area of a circuit board used in a conventional MEMS microphone, so that materials required for manufacturing the circuit board and a housing can be reduced, and production costs of the MEMS microphone can be reduced.

In a possible implementation, the step of providing a microphone intermediate body and a circuit board includes: forming a first wiring layer on an upper surface of the back plate and the upper surface of the ASIC chip, where the first wiring layer is electrically connected between the back plate and the ASIC chip; and in the step of forming a first sacrificial layer on an upper surface of the silicon substrate and an upper surface of the ASIC chip, the first sacrificial layer covers the first wiring layer. The first wiring layer is arranged, so that the back plate can be electrically connected to the ASIC chip.

In a possible implementation, after the step of forming a first sacrificial layer on an upper surface of the silicon substrate and an upper surface of the ASIC chip, and before the step of forming a diaphragm on a surface of the first sacrificial layer facing away from the silicon substrate and the ASIC chip, the method for preparing a MEMS microphone further includes: forming a first electrical connection portion in the first sacrificial layer, where the first electrical connection portion is spaced apart from the first wiring layer, and is electrically connected to the ASIC chip; and after the step of forming a diaphragm on a surface of the first sacrificial layer facing away from the silicon substrate and the ASIC chip, and before the step of forming a second sacrificial layer on a lower surface of the silicon substrate and a lower surface of the ASIC chip, the method for preparing a MEMS microphone further includes: forming a second electrical connection portion in the diaphragm and the first sacrificial layer, where the second electrical connection portion is electrically connected to both the first electrical connection portion and the diaphragm, to obtain a second wiring layer, where the second wiring layer is electrically connected between the diaphragm and the ASIC chip. The second wiring layer is arranged, so that the diaphragm can be electrically connected to the ASIC chip.

In a possible implementation, after the step of forming a diaphragm on a surface of the first sacrificial layer facing away from the silicon substrate and the ASIC chip, and before the step of forming a second sacrificial layer on a lower surface of the silicon substrate and a lower surface of the ASIC chip, the method for preparing a MEMS microphone further includes: forming a third electrical connection portion on the lower surface of the silicon substrate and the lower surface of the ASIC chip, where the third electrical connection portion is electrically connected to the ASIC chip; in the step of forming a second sacrificial layer on a lower surface of the silicon substrate and a lower surface of the ASIC chip, the second sacrificial layer covers the third electrical connection portion; and after the step of forming a second sacrificial layer on a lower surface of the silicon substrate and a lower surface of the ASIC chip, and before the step of etching the second sacrificial layer, the silicon substrate, and the first sacrificial layer in a direction from the lower surface of the silicon substrate to the upper surface of the silicon substrate, the method for preparing a MEMS microphone further includes: forming a fourth electrical connection portion in the second sacrificial layer, where the fourth electrical connection portion is electrically connected to the third electrical connection portion, to obtain a third wiring layer, where the third wiring layer is electrically connected to the ASIC chip. The third wiring layer is arranged, so that the ASIC chip can be electrically connected to the circuit board.

In a possible implementation, the step of providing a microphone intermediate body and a circuit board includes: mounting the ASIC chip on the side surface of the silicon substrate, to obtain a microphone prefabricated body; etching the silicon substrate to form a plurality of etched grooves, where the plurality of etched grooves are arranged at intervals from each other, and openings of the plurality of etched grooves are all located on the upper surface of the silicon substrate; annealing the microphone prefabricated body to form a cavity inside the silicon substrate, to obtain a back plate intermediate body and the support frame intermediate body, where the back plate intermediate body is fixedly connected to the upper surface of the support frame intermediate body; and etching the back plate intermediate body to form a plurality of through holes, to obtain the back plate, where the plurality of through holes are arranged at intervals, all run through the back plate in a thickness direction of the back plate, and are all in communication with the cavity.

In a possible implementation, the step of mounting the MEMS chip on the circuit board, to obtain a MEMS microphone includes: fixedly mounting a housing on the circuit board, and enabling the housing to cover the MEMS chip and the ASIC chip. The housing may protect the MEMS chip and the ASIC chip, and can prevent another electromagnetic signal from interfering with normal use of the MEMS chip and the ASIC chip.

According to a fourth aspect, this application further provides a method for preparing a MEMS microphone, including: providing a MEMS chip, an ASIC chip, and a circuit board, where the circuit board is provided with a sound hole, and the sound hole runs through the circuit board in a thickness direction of the circuit board; mounting the ASIC chip on a side surface of the MEMS chip, where the ASIC chip is electrically connected to the MEMS chip; and mounting the MEMS chip on the circuit board, to obtain a MEMS microphone, where the MEMS chip covers the sound hole and is electrically connected to the circuit board, a sound cavity of the MEMS chip is in communication with the sound hole, and the ASIC chip is electrically connected to the circuit board. According to the method for preparing a MEMS microphone provided in this embodiment, a structure obtained after the MEMS chip and the ASIC chip are assembled is more compact, and mounting space of the MEMS chip and the ASIC chip in the MEMS microphone is reduced, thereby helping reduce an overall volume of the MEMS microphone, and facilitating a miniaturized design of the MEMS microphone, thereby helping achieve a light and thin design of an electronic device. In addition, a mounting area occupied by the MEMS chip and the ASIC chip on the circuit board is reduced, so that materials required for manufacturing the circuit board and a housing can be reduced, and production costs of the MEMS microphone can be reduced.

In a possible implementation, the ASIC chip includes a chip body and an active layer, where the active layer and the chip body are stacked; and the step of mounting the ASIC chip on a side surface of the MEMS chip includes: performing wafer bonding on a surface of the chip body facing away from the active layer and the side surface of the MEMS chip, to form a connecting layer. In the preparation method, both wires between the ASIC chip and the MEMS chip and wires between the ASIC chip and the circuit board are arranged inside the chips, so that a signal transmission distance between the ASIC chip and the MEMS chip and a signal transmission distance between the ASIC chip and the circuit board are shortened, thereby helping increase a signal transmission speed between the MEMS chip and the ASIC chip and between the ASIC chip and the circuit board.

In a possible implementation, the ASIC chip includes a chip body and an active layer, where the active layer and the chip body are stacked; and the step of mounting the ASIC chip on a side surface of the MEMS chip includes: performing soldering on a surface of the chip body facing away from the active layer and the side surface of the MEMS chip, to form a first solder portion, a second solder portion, and a third solder portion, to obtain a connecting layer. In the preparation method, fixing between the MEMS chip and the ASIC chip is implemented by using a soldering process. In this way, costs are low, which helps reduce production costs of the MEMS microphone 120.

In a possible implementation, the step of mounting the ASIC chip on a side surface of the MEMS chip includes: providing an anisotropic conductive film; fixedly mounting the anisotropic conductive film on the side surface of the MEMS chip; and mounting the ASIC chip on a surface of the anisotropic conductive film facing away from the MEMS chip. The anisotropic conductive film is attached, so that the MEMS chip can be electrically connected to the ASIC chip. In this way, the operation is simple, which helps improve production efficiency of the MEMS microphone.

In a possible implementation, the MEMS chip includes a back plate, a support frame, a first support layer, a diaphragm, a first wiring layer, a second wiring layer, and a third wiring layer, where the back plate is fixedly connected to a side of the support frame facing away from the circuit board, the first support layer is arranged on a surface of the back plate facing away from the support frame, the diaphragm is arranged on a surface of the first support layer facing away from the back plate, both the first wiring layer and the second wiring layer are arranged on a side of the back plate facing away from the support frame, the second wiring layer is spaced apart from the first wiring layer, and the third wiring layer is arranged on a side of the support frame facing the circuit board; the ASIC chip includes a chip body and an active layer, where the active layer and the chip body are stacked; and the step of mounting the ASIC chip on a side surface of the MEMS chip includes: providing a die attach film, a first wire, a second wire, and a third wire; fixedly mounting the die attach film on an outer peripheral surface of the support frame; mounting the ASIC chip on a surface of the die attach film facing away from the support frame, where the chip body and the active layer are sequentially stacked on the surface of the die attach film facing away from the support frame; electrically connecting the first wire between the first wiring layer and the active layer; electrically connecting the second wire between the second wiring layer and the active layer; and electrically connecting the third wire between the third wiring layer and the active layer. In the preparation method, the electrical connection between the MEMS chip and the ASIC chip and the electrical connection between the ASIC chip and the circuit board are implemented through wire bonding, so that the production costs are low. In addition, there is no need to additionally arrange a wiring layer inside the ASIC chip, which helps simplify a production process of the MEMS microphone and improve the production efficiency of the MEMS microphone.

### BRIEF DESCRIPTION OF THE DRAWINGS

To describe technical solutions in embodiments of this application or the background technology more clearly, the following describes the accompanying drawings required for describing embodiments of this application or the background technology.

FIG. 1 is a schematic diagram of a structure of an electronic device according to an embodiment of this application;

FIG. 2 is a schematic diagram of a structure of a MEMS microphone in the electronic device shown in FIG. 1;

FIG. 3 is a schematic diagram of a structure of the MEMS microphone shown in FIG. 2 after being cut along a line A-A in a first embodiment;

FIG. 4 is a schematic diagram of a structure of an ASIC chip in the MEMS microphone shown in FIG. 3;

FIG. 5 is a schematic diagram of a structure of the MEMS microphone shown in FIG. 2 after being cut along a line A-A in a second embodiment;

FIG. 6 is a schematic diagram of a structure of the MEMS microphone shown in FIG. 2 after being cut along a line A-A in a third embodiment;

FIG. 7 is a schematic diagram of a structure of the MEMS microphone shown in FIG. 2 after being cut along a line A-A in a fourth embodiment;

FIG. 8 is a schematic diagram of a structure of the MEMS microphone shown in FIG. 2 after being cut along a line A-A in a fifth embodiment;

FIG. 9 is a schematic diagram of a structure of the MEMS microphone shown in FIG. 2 after being cut along a line A-A in a sixth embodiment;

FIG. 10 is a schematic diagram of a structure of the MEMS microphone shown in FIG. 2 after being cut along a line A-A in a seventh embodiment;

FIG. 11 is a schematic flowchart of a first method for preparing a MEMS microphone according to an embodiment of this application;

FIG. 12 is a schematic diagram of a structure of a silicon substrate of a microphone intermediate body provided in Step S1;

FIG. 13 is a schematic diagram of a structure of a microphone prefabricated body in Step S11;

FIG. 14 is a schematic diagram of a structure obtained after a plurality of etched grooves are formed on a silicon substrate in Step S12;

FIG. 15 is a schematic diagram of a structure obtained after a cavity is formed inside a silicon substrate in Step S13;

FIG. 16 is a schematic diagram of a structure obtained after a first wiring layer is formed on an upper surface of a back plate intermediate body and an upper surface of an ASIC chip in Step S14;

FIG. 17 is a schematic diagram of a structure obtained after a back plate is obtained in Step S15;

FIG. 18 is a schematic diagram of a structure obtained after a first electrical connection portion is formed in a first sacrificial layer in Step S3;

FIG. 19 is a schematic diagram of a structure obtained after a diaphragm is formed on a surface of a first sacrificial layer facing away from a silicon substrate and an ASIC chip in Step S4;

FIG. 20 is a schematic diagram of a structure obtained after a second wiring layer is obtained in Step S5;

FIG. 21 is a schematic diagram of a structure obtained after a third electrical connection portion is formed on a lower surface of a silicon substrate and a lower surface of an ASIC chip in Step S6;

FIG. 22 is a schematic diagram of a structure obtained after a third wiring layer is obtained in Step S8;

FIG. 23 is a schematic diagram of a structure obtained after a MEMS chip is obtained in Step S9;

FIG. 24 is a schematic flowchart of a second method for preparing a MEMS microphone according to an embodiment of this application;

FIG. 25 is a schematic diagram of a structure obtained after a plurality of etched grooves are formed on a silicon substrate in Step S101′;

FIG. 26 is a schematic diagram of a structure obtained after a back plate intermediate body and a support plate intermediate body are obtained in Step S102′;

FIG. 27 is a schematic diagram of a structure obtained after a first wiring layer is formed on an upper surface of a back plate intermediate body in Step S103′;

FIG. 28 is a schematic diagram of a structure obtained after a back plate is obtained in Step S104′;

FIG. 29 is a schematic diagram of a structure obtained after a first electrical connection portion is formed in a first sacrificial layer in Step S106′;

FIG. 30 is a schematic diagram of a structure obtained after a diaphragm is formed on a surface of a first sacrificial layer facing away from a silicon substrate in Step S107′;

FIG. 31 is a schematic diagram of a structure obtained after a second wiring layer is obtained in Step S108′;

FIG. 32 is a schematic diagram of a structure obtained after a third electrical connection portion is formed on a lower surface of a silicon substrate in Step S109′;

FIG. 33 is a schematic diagram of a structure obtained after a third wiring layer is obtained in Step S111′; and FIG. 34 is a schematic diagram of a structure obtained after a MEMS chip is obtained in Step S112′.

### DETAILED DESCRIPTION OF ILLUSTRATIVE EMBODIMENTS

The following describes embodiments of this application with reference to the accompanying drawings in embodiments of this application.

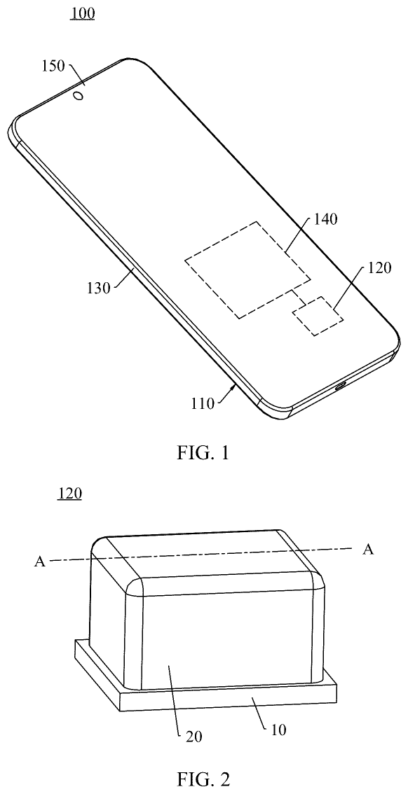

Refer to FIG. 1 and FIG. 2 together. FIG. 1 is a schematic diagram of a structure of an electronic device 100 according to an embodiment of this application. FIG. 2 is a schematic diagram of a structure of a MEMS microphone 120 in the electronic device 100 shown in FIG. 1.

An embodiment of this application provides the electronic device 100. The electronic device 100 may be, but is not limited to, a mobile phone, a tablet computer, a television, a headset, a speaker, a personal computer (Personal Computer, PC), a smart speaker, a smart screen, an in-vehicle display screen, or the like. The electronic device 100 may alternatively be another MEMS device with a relatively large cavity, such as a gyroscope.

In this embodiment, the electronic device 100 may include a housing 110, a middle frame 130, a processor 140, a display screen 150, and the MEMS microphone 120. Both the housing 110 and the display screen 150 are mounted on the middle frame 130. The display screen 150 is arranged opposite to the housing 110. The display screen 150 is configured to display a picture. The middle frame 130 is located between the display screen 150 and the housing 110. Both the processor 140 and the MEMS microphone 120 are mounted inside the housing 110. The housing 110 may protect the processor 140 and the MEMS microphone 120.

The MEMS microphone 120 is electrically connected to the processor 140. The processor 140 may process a sound signal received by the MEMS microphone, so that the MEMS microphone 120 can implement a sound receiving function.

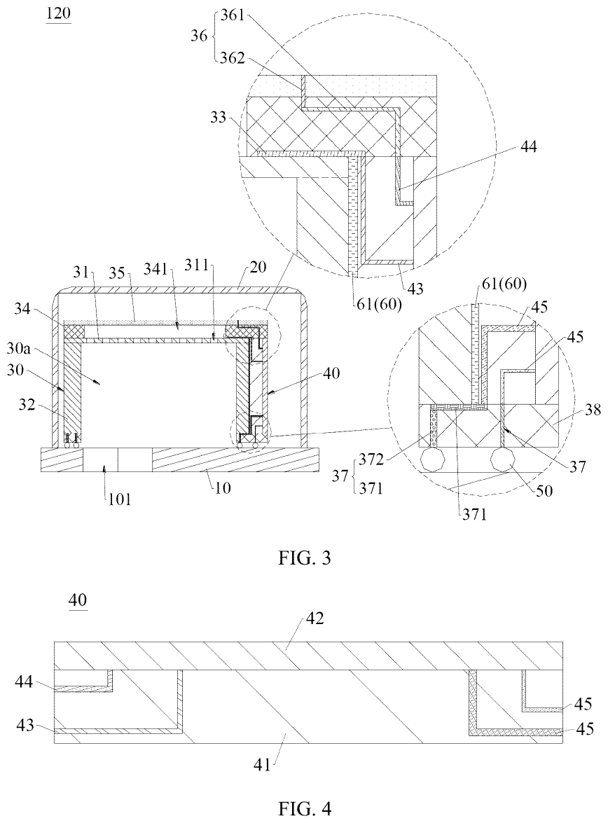

Refer to FIG. 3. FIG. 3 is a schematic diagram of a structure of the MEMS microphone 120 shown in FIG. 2 after being cut along a line A-A in a first embodiment.

The MEMS microphone 120 includes a circuit board 10, a housing 20, a MEMS chip 30, and an ASIC chip 40. The MEMS chip 30, the ASIC chip 40, and the housing 20 are all arranged on a side of the circuit board 10. The circuit board 10 is a printed circuit board (Printed Circuit Board, PCB). The circuit board 10 is provided with a sound hole 101, and the sound hole 101 runs through the circuit board 10 in a thickness direction of the circuit board 10, to facilitate inflow of the sound signal. The MEMS chip 30 is fixedly mounted on the circuit board 10, and covers the sound hole 101 of the circuit board 10. The ASIC chip 40 is mounted on a side surface of the MEMS chip 30, and is electrically connected to both the MEMS chip 30 and the circuit board 10. The ASIC chip 40 may be fixedly connected to the MEMS chip 30 by using a wafer bonding process. The MEMS chip 30 is configured to sense and detect the sound signal flowing from the sound hole 101, and convert the sound signal into an electrical signal and transmit the electrical signal to the ASIC chip 40. The ASIC chip 40 receives the electrical signal output by the MEMS chip 30, and processes and amplifies the electrical signal, so that the MEMS microphone 120 can provide a sound receiving function for the electronic device 100. The housing 20 is fixedly mounted on the circuit board 10, and covers the MEMS chip 30 and the ASIC chip 40. For example, the housing 20 is made of a metal material. The housing 20 may protect the MEMS chip 30 and the ASIC chip 40, and can prevent another electromagnetic signal from interfering with normal use of the MEMS chip 30 and the ASIC chip 40.

In addition, when the MEMS chip 30 and the ASIC chip 40 are fixed to the circuit board 10, both the MEMS chip 30 and the ASIC chip 40 are spaced apart from the circuit board 10. In this case, the MEMS microphone 120 may further include a fixing member 50. The fixing member 50 is electrically connected between the MEMS chip 30 and the circuit board 10, to implement a fixed connection between the MEMS chip 30 and the circuit board 10, so that the ASIC chip 40 is electrically connected to the circuit board 10. For example, the fixing member 50 may be a solder ball formed in a process of soldering the MEMS chip 30 and the circuit board 10.

Still refer to FIG. 3. The MEMS chip 30 includes a back plate 31, a support frame 32, a first support layer 34, a diaphragm 35, and a second support layer 38. The back plate 31 is fixedly connected to a side of the support frame 32 facing away from the circuit board 10. The first support layer 34 is arranged on a surface of the back plate 31 facing away from the support frame 32. The diaphragm 35 is arranged on a surface of the first support layer 34 facing away from the back plate 31. The second support layer 38 is arranged on a surface of the support frame 32 facing away from the back plate 31.

In this embodiment, the support frame 32 and the back plate 31 may be integrally formed. The support frame 32 and the back plate 31 enclose a sound cavity 30a. Specifically, an opening of the sound cavity 30a is arranged facing the circuit board 10. The sound cavity 30a is in communication with the sound hole 101, so that a sound signal of an external environment can enter the MEMS chip 30. The back plate 31 is provided with a plurality of through holes 311. The plurality of through holes 311 all run through the back plate 31 in a thickness direction of the back plate 31, and are arranged at intervals from each other. Each through hole 311 is in communication with the sound cavity 30a, so that the sound signal can pass through the back plate 31.

In this embodiment, the first support layer 34 is arranged on the surface of the back plate 31 facing away from the support frame 32 and a surface of the ASIC chip 40 facing away from the circuit board 10. Specifically, a peripheral surface of the first support layer 34 exceeds a peripheral surface of the back plate 31, and covers at least a part of the surface of the ASIC chip 40 facing away from the circuit board 10. A thickness of the first support layer 34 ranges from 1 um to 4 μm. The first support layer 34 is provided with an avoidance hole 341, and the avoidance hole 341 runs through the first support layer 34 in a thickness direction of the first support layer 34. The avoidance hole 341 avoids the plurality of through holes 311 of the back plate 31, to prevent the first support layer 34 from hindering transmission of the sound signal.

In this embodiment, the diaphragm 35 is arranged on the surface of the first support layer 34 facing away from the back plate 31 and a surface of the first support layer 34 facing away from the ASIC chip 40. An orthographic projection of the diaphragm 35 on the back plate 31 covers at least a part of the surface of the ASIC chip 40 facing away from the circuit board 10. For example, the diaphragm 35 is made of polysilicon. A thickness of the diaphragm 35 ranges from 0.2 μm to 1 μm. In this embodiment, the orthographic projection of the diaphragm 35 on the back plate 31 covers the plurality of through holes 311 of the back plate 31 and the ASIC chip 40. In other words, the diaphragm 35 is located on a top side of the back plate 31. In this case, a sound pickup mode of the MEMS microphone 120 is an upper sound pickup mode.

In this arrangement, the ASIC chip 40 may support the diaphragm 35, and an effective area of the diaphragm 35 significantly increases, thereby speeding up a response speed of the diaphragm 35 to the sound signal, and reducing an acoustic conversion loss ratio of the diaphragm 35, so that acoustic efficiency of the MEMS microphone 120 can be improved, and acoustic performance of the MEMS microphone 120 can be improved. The acoustic efficiency of the MEMS microphone 120 provided in this application is 1.76 times acoustic efficiency of a conventional MEMS microphone 120.

In some other embodiments, the diaphragm 35 may alternatively be fixedly connected to the support frame 32, located on a side of the back plate 31 facing the circuit board 10, and spaced apart from the back plate 31. In other words, the diaphragm 35 is located on a bottom side of the back plate 31. In this case, the sound pickup mode of the MEMS microphone 120 is a bottom sound pickup mode. In this arrangement, there is no need to additionally arrange the first support layer 34 between the diaphragm 35 and the back plate 31, so that a structure of the MEMS chip 30 can be simplified, which helps reduce a production process of the MEMS chip 30.

In this embodiment, the diaphragm 35 and the back plate 31 jointly form a capacitor structure. It may be understood that, the sound signal of the external environment enters the sound cavity 30a of the MEMS chip 30 through the sound hole 101 of the circuit board 10, and passes through the back plate 31 to act on the diaphragm 35. When the diaphragm 35 is subjected to a sound pressure of the sound signal, the diaphragm is deformed, and a capacitance value between the diaphragm 35 and the back plate 31 changes. The ASIC chip 40 can detect a capacitance change between the diaphragm 35 and the back plate 31, and convert the capacitance change into the electrical signal for outputting, so that acoustic-electric conversion is completed, and the MEMS microphone 120 implements a sound receiving function.

In this embodiment, the second support layer 38 is arranged on a surface of the support frame 32 facing the circuit board 10 and a surface of the ASIC chip facing the circuit board 10, and is arranged around the opening of the sound cavity 30a. Specifically, a peripheral surface of the second support layer 38 exceeds an outer peripheral surface of the support frame 32, and covers at least a part of the surface of the ASIC chip 40 facing the circuit board 10. The MEMS chip 30 may be fixedly connected to the circuit board 10 through the second support layer 38.

The MEMS chip 30 further includes a first wiring layer 33, a second wiring layer 36, and a third wiring layer 37. For example, the first wiring layer 33, the second wiring layer 36, and the third wiring layer 37 each are made of metal copper. In some other embodiments, the first wiring layer 33, the second wiring layer 36, and the third wiring layer 37 each may alternatively be made of metal aluminum.

In this embodiment, both the first wiring layer 33 and the second wiring layer 36 are arranged on a side of the back plate 31 facing away from the support frame 32. The first wiring layer 33 is arranged on the surface of the back plate 31 facing away from the support frame 32, covers the first support layer 34, and is electrically connected between the back plate 31 and the ASIC chip 40. For example, the first wiring layer 33 spans the surface of the back plate 31 facing away from the support frame 32 and a surface of a side of the ASIC chip 40 close to the back plate 31. An end of the first wiring layer 33 away from the back plate 31 is exposed relative to the peripheral surface of the first support layer 34. In some other embodiments, the first wiring layer 33 may alternatively be arranged on the surface of the back plate 31 facing away from the support frame 32, or the first wiring layer 33 may alternatively be arranged on the surface of the side of the ASIC chip 40 close to the back plate 31. This is not limited in embodiments of this application.

In this embodiment, the second wiring layer 36 is spaced apart from the first wiring layer 33. The second wiring layer 36 is arranged inside the diaphragm 35 and the first support layer 34, and is electrically connected between the diaphragm 35 and the ASIC chip 40. For example, an end of the second wiring layer 36 away from the diaphragm 35 is exposed relative to a surface of the first support layer 34 facing the back plate 31. Specifically, the second wiring layer 36 includes a first electrical connection portion 361 and a second electrical connection portion 362 connected to each other. The first electrical connection portion 361 is arranged inside the first support layer 34, and is spaced apart from the first wiring layer 33. The second electrical connection portion 362 is electrically connected to both the first electrical connection portion 361 and the diaphragm 35. One part of the second electrical connection portion 362 is arranged inside the first support layer 34, and the other part of the second electrical connection portion 362 is arranged inside the diaphragm 35.

It may be understood that, the first wiring layer 33 and the second wiring layer 36 are arranged, so that the diaphragm 35 and the back plate 31 each can be electrically connected to the ASIC chip 40, and the ASIC chip 40 can detect the capacitance change between the diaphragm 35 and the back plate 31, so that conversion between the sound signal and the electrical signal can be implemented, so that the sound receiving function of the MEMS microphone 120 can be implemented.

The third wiring layer 37 is arranged on a side of the support frame 32 facing the circuit board 10, and is electrically connected between the ASIC chip 40 and the circuit board 10. An end of the third wiring layer 37 close to the ASIC chip 40 is exposed relative to a surface of the second support layer 38 facing the support frame 32. Specifically, the third wiring layer 37 may include a third electrical connection portion 371 and a fourth electrical connection portion 372 connected to each other. The third electrical connection portion 371 spans the surface of the support frame 32 facing the circuit board 10 and the surface of the ASIC chip facing the circuit board 10. The fourth electrical connection portion 372 is electrically connected to the third electrical connection portion 371.

In this embodiment, there may be a plurality of third wiring layers 37. The plurality of third wiring layers 37 are spaced apart from each other. For example, there are two third wiring layers 37. The two third wiring layers 37 are both electrically connected to the ASIC chip, to implement transmission of different electrical signals between the ASIC chip 40 and the circuit board 10. It should be noted that, a shape and an arrangement manner of each third wiring layer 37 may be the same or different, which needs to be determined according to a specific electrical connection manner between the MEMS chip and the ASIC chip.

Refer to FIG. 4. FIG. 4 is a schematic diagram of a structure of an ASIC chip 40 in the MEMS microphone 120 shown in FIG. 3.

The ASIC chip 40 includes a chip body 41 and an active layer 42, where the chip body 41 and the active layer 42 are stacked on the side surface of the MEMS chip 30. Specifically, the active layer 42 is arranged on a surface of the chip body 41 facing away from the MEMS chip 30. The ASIC chip 40 further includes a fourth wiring layer 43, a fifth wiring layer 44, and a sixth wiring layer 45. The fourth wiring layer 43, the fifth wiring layer 44, and the sixth wiring layer 45 are all arranged inside the chip body 41, are arranged at intervals from each other, and are all electrically connected to the active layer 42. For example, the fourth wiring layer 43, the fifth wiring layer 44, and the sixth wiring layer 45 each are made of metal copper. In some other embodiments, the fourth wiring layer 43, the fifth wiring layer 44, and the sixth wiring layer 45 may alternatively be made of metal aluminum. This is not limited in embodiments of this application.

In this embodiment, the fourth wiring layer 43 is electrically connected between the active layer 42 and the first wiring layer 33, so that the active layer 42 of the ASIC chip 40 is electrically connected to the back plate 31. Specifically, an end of the fourth wiring layer 43 away from the active layer 42 is exposed relative to a surface of the chip body 41 facing away from the circuit board 10, and is electrically connected to the first wiring layer 33.

The fifth wiring layer 44 is spaced apart from the fourth wiring layer 43, and is electrically connected between the active layer 42 and the second wiring layer 36, so that the active layer 42 of the ASIC chip 40 is electrically connected to the diaphragm 35. Specifically, an end of the fifth wiring layer 44 away from the active layer 42 is exposed relative to the surface of the chip body 41 facing away from the circuit board 10, and is electrically connected to the second wiring layer 36.

The sixth wiring layer 45 is located on a side of the fourth wiring layer 43 and the fifth wiring layer 44 facing the circuit board 10, is spaced apart from both the fourth wiring layer 43 and the fifth wiring layer 44, and is electrically connected between the active layer 42 and the third wiring layer 37. Specifically, an end of the sixth wiring layer 45 away from the active layer 42 is exposed relative to a surface of the chip body 41 facing the circuit board 10, and is electrically connected to the third wiring layer 37. In this embodiment, there may be a plurality of sixth wiring layers 45. The plurality of sixth wiring layers 45 are spaced apart from each other. Each sixth wiring layer 45 is electrically connected between the active layer 42 and a third wiring layer 37. For example, there are two sixth wiring layers 45.

In addition, the MEMS microphone 120 further includes a connecting layer 60. The connecting layer 60 is connected between the outer peripheral surface of the support frame 32 and the ASIC chip 40, so that the MEMS chip 30 can be electrically connected to the ASIC chip 40. In this embodiment, the connecting layer 60 is a wafer bonding layer 61, and is electrically connected to the first wiring layer 33, the second wiring layer 36, and the third wiring layer 37 of the MEMS chip 30 and the active layer 42 of the ASIC chip 40. It should be noted that, the wafer bonding layer 61 is formed by combining the outer peripheral surface of the support frame 32 in the MEMS chip 30 with a surface of the chip body 41 facing away from the active layer 42 in the ASIC chip by using the wafer bonding process.

In this embodiment, after the ASIC chip 40 is fixedly connected to the side surface of the MEMS chip 30, the MEMS chip 30 is fixed to a surface of the circuit board 10. In this case, an end of the third wiring layer 37 away from the ASIC chip 40 is electrically connected to the circuit board 10, so that the ASIC chip 40 is electrically connected to the circuit board 10, so that the MEMS chip 30 can be electrically connected to the circuit board 10 through the ASIC chip 40. In this arrangement, both wires between the ASIC chip 40 and the MEMS chip 30 and wires between the ASIC chip 40 and the circuit board 10 are arranged inside the chips, so that a signal transmission distance between the ASIC chip 40 and the MEMS chip 30 and a signal transmission distance between the ASIC chip 40 and the circuit board 10 are shortened, thereby helping increase a signal transmission speed between the MEMS chip 30 and the ASIC chip 40 and between the ASIC chip 40 and the circuit board 10. In addition, both the electrical connection between the MEMS chip 30 and the ASIC chip 40 and the electrical connection between the ASIC chip 40 and the circuit board 10 do not need to be implemented by using a gold wire required for wire bonding, thereby also helping reduce production costs of the MEMS microphone 120.

In this embodiment, the ASIC chip 40 is fixedly mounted on the side surface of the MEMS chip 30, so that a structure obtained after the MEMS chip 30 and the ASIC chip 40 are assembled can be more compact, and mounting space of the MEMS chip 30 and the ASIC chip 40 in the MEMS microphone 120 can be reduced, thereby helping reduce an overall volume of the MEMS microphone 120, and facilitating a miniaturized design of the MEMS microphone 120, thereby helping achieve a light and thin design of the electronic device 100. The overall volume of the MEMS microphone 120 provided in this application is reduced by 30% to 40% compared with that of the conventional MEMS microphone. In addition, a mounting area occupied by the MEMS chip 30 and the ASIC chip 40 on the circuit board 10 is reduced, so that materials required for manufacturing the circuit board 10 and the housing 20 can be reduced, and the production costs of the MEMS microphone 120 can be reduced. An area of the circuit board 10 used in the MEMS microphone 120 provided in this application is reduced by 50% compared with an area of a circuit board 10 used in the conventional MEMS microphone 120.

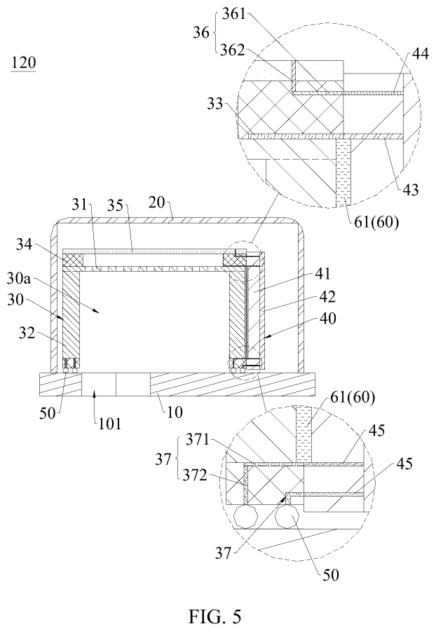

Refer to FIG. 5. FIG. 5 is a schematic diagram of a structure of the MEMS microphone 120 shown in FIG. 2 after being cut along a line A-A in a second embodiment.

The MEMS microphone 120 described in this embodiment is different from the MEMS microphone 120 described in the first embodiment in that a first support layer 34 is arranged on a surface of a back plate 31 facing away from a support frame 32. A peripheral surface of the first support layer 34 is flush with a peripheral surface of the back plate 31. A diaphragm 35 is arranged on a surface of the first support layer 34 facing away from the back plate 31. A peripheral surface of the diaphragm 35 is flush with the peripheral surface of the first support layer 34. A second support layer 38 is arranged on a surface of the support frame 32 facing a circuit board 10. A peripheral surface of the second support layer 38 is flush with a peripheral surface of the support frame 32.

In this embodiment, a first wiring layer 33 is arranged on a surface of the back plate 31 facing away from the support frame 32, covers the first support layer 34, and is electrically connected between the back plate 31 and the ASIC chip 40, so that the back plate 31 is electrically connected to the ASIC chip 40. Specifically, an end of the first wiring layer 33 away from the back plate 31 is exposed relative to the peripheral surface of the first support layer 34.

A second wiring layer 36 is arranged inside the diaphragm 35 and the first support layer 34, and is electrically connected between the diaphragm 35 and the ASIC chip 40, so that the diaphragm 35 is electrically connected to the ASIC chip 40. Specifically, an end of the second wiring layer 36 away from the diaphragm 35 is exposed relative to the peripheral surface of the first support layer 34.

A third wiring layer 37 is arranged on a side of the support frame 32 facing the circuit board 10, covers the second support layer 38, and is electrically connected between the ASIC chip 40 and the circuit board 10, so that the ASIC chip 40 is electrically connected to the circuit board 10, so that the MEMS chip 30 can be electrically connected to the circuit board 10 through the ASIC chip 40. Specifically, an end of the third wiring layer 37 close to the ASIC chip 40 is exposed relative to the peripheral surface of the second support layer 38. For example, there are two third wiring layers 37. The two third wiring layers 37 are spaced apart from each other. Ends of the two third wiring layers 37 close to the ASIC chip 40 are both exposed relative to the peripheral surface of the second support layer 38.

In this embodiment, an end of a fourth wiring layer 43 of the ASIC chip 40 away from an active layer 42 is exposed relative to a surface of a chip body 41 facing away from the active layer 42, and is electrically connected to the first wiring layer 33, so that the active layer 42 of the ASIC chip 40 is electrically connected to the back plate 31.

A fifth wiring layer 44 of the ASIC chip 40 is spaced apart from the fourth wiring layer 43. An end of the fifth wiring layer 44 away from the active layer 42 is exposed relative to a surface of the chip body 41 facing away from the circuit board 10, and is electrically connected to the second wiring layer 36, so that the active layer 42 of the ASIC chip 40 is electrically connected to the diaphragm 35.

A sixth wiring layer 45 of the ASIC chip 40 is located on a side of the fourth wiring layer 43 and the fifth wiring layer 44 facing the circuit board 10, and is spaced apart from both the fourth wiring layer 43 and the fifth wiring layer 44. An end of the sixth wiring layer 45 away from the active layer 42 is exposed relative to a surface of the chip body 41 facing away from the active layer 42, and is electrically connected to the third wiring layer 37. For example, there are two sixth wiring layers 45. Each sixth wiring layer 45 is electrically connected between the active layer 42 and a third wiring layer 37.

In this embodiment, wires are arranged inside the MEMS chip 30 and the ASIC chip 40, so that a signal transmission distance between the ASIC chip 40 and the MEMS chip 30 and a signal transmission distance between the ASIC chip 40 and the circuit board 10 are shortened, thereby helping increase a signal transmission speed between the MEMS chip 30 and the ASIC chip 40 and between the ASIC chip 40 and the circuit board 10. In addition, both the electrical connection between the MEMS chip 30 and the ASIC chip 40 and the electrical connection between the ASIC chip 40 and the circuit board 10 do not need to be implemented by using a gold wire required for wire bonding, thereby also helping reduce production costs of the MEMS microphone 120.

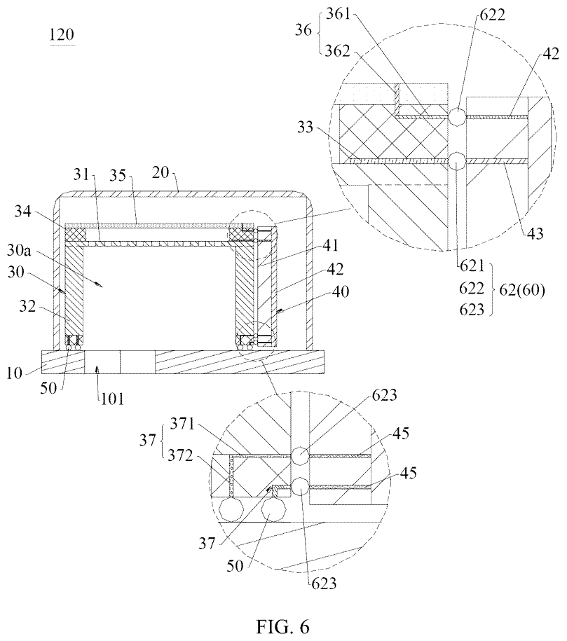

Refer to FIG. 6. FIG. 6 is a schematic diagram of a structure of the MEMS microphone 120 shown in FIG. 2 after being cut along a line A-A in a third embodiment.

The MEMS microphone 120 described in this embodiment is different from the MEMS microphone 120 described in the second embodiment in that a connecting layer 60 is a solder layer 62. In other words, the connecting layer 60 is formed by using a soldering process. In this embodiment, the solder layer 62 includes a first solder portion 621, a second solder portion 622, and a third solder portion 623. The first solder portion 621, the second solder portion 622, and the third solder portion 623 are all arranged between the side surface of the MEMS chip 30 and a surface of a chip body 41 facing away from an active layer 42, and are arranged at intervals from each other. A solder resist is coated between the first solder portion 621 and the second solder portion 622, to prevent the first solder portion 621 and the second solder portion 622 from coming into contact with each other, so that a short circuit between the MEMS chip 30 and the ASIC chip 40 can be avoided.

Specifically, the first solder portion 621 is electrically connected between a first wiring layer 33 and a fourth wiring layer 43, so that the first wiring layer 33 is electrically connected to the active layer 42. The second solder portion 622 is electrically connected between a second wiring layer 36 and a fifth wiring layer 44, so that the second wiring layer 36 is electrically connected to the active layer 42. The third solder portion 623 is electrically connected between a third wiring layer 37 and a sixth wiring layer 45, so that the third wiring layer 37 is electrically connected to the active layer 42. For example, there are two third solder portions 623. Each third solder portion 623 is electrically connected between a third wiring layer 37 and a sixth wiring layer 45. In addition, a solder resist is also coated between the two third solder portions 623, to avoid a short circuit caused by contact between two adjacent third solder portions 623.

In this arrangement, reliability of the connection between the MEMS chip 30 and the ASIC chip 40 can be enhanced, and fixing between the MEMS chip 30 and the ASIC chip 40 can also be implemented by using a soldering process. In this way, costs are low, which helps reduce production costs of the MEMS microphone 120.

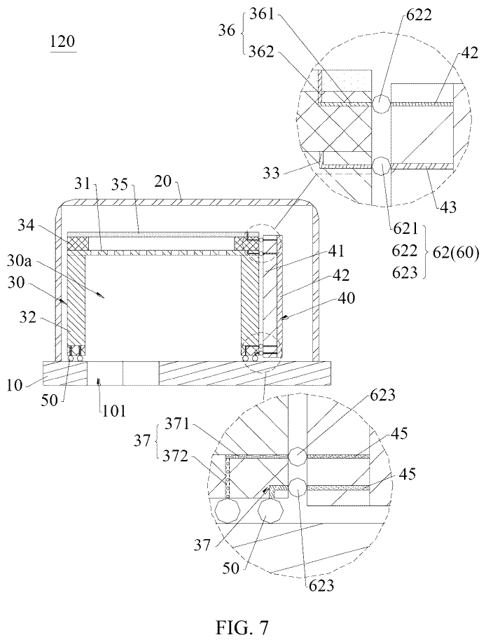

Refer to FIG. 7. FIG. 7 is a schematic diagram of a structure of the MEMS microphone 120 shown in FIG. 2 after being cut along a line A-A in a fourth embodiment.

The MEMS microphone 120 described in this embodiment is different from the MEMS microphone 120 described in the third embodiment in that a first wiring layer 33 is arranged inside a back plate 31. An end of the first wiring layer 33 away from the back plate 31 is exposed relative to a peripheral surface of the back plate 31.

In this arrangement, an interval between the first wiring layer 33 and a second wiring layer 36 can increase. When a first solder portion 621 is electrically connected between the first wiring layer 33 and a fourth wiring layer 43, and a second solder portion 622 is electrically connected between the second wiring layer 36 and a fifth wiring layer 44, a distance between the first solder portion 621 and the second solder portion 622 also increases accordingly, so that the first solder portion 621 and the second solder portion 622 can be prevented from coming into contact with each other. In this way, there is no need to additionally coat a solder resist between the first solder portion 621 and the second solder portion 622, and a short circuit between the MEMS chip 30 and the ASIC chip 40 can be avoided.

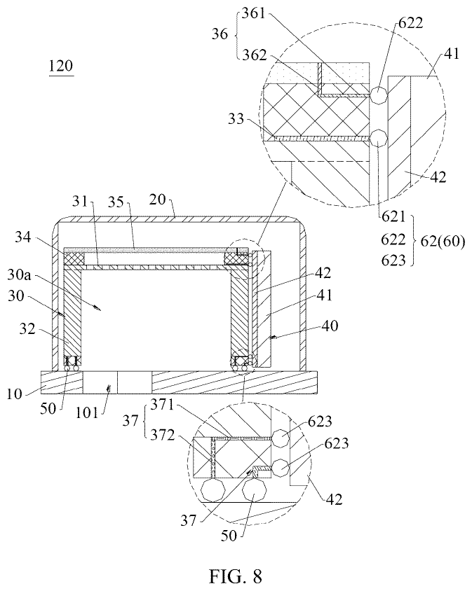

Refer to FIG. 8. FIG. 8 is a schematic diagram of a structure of the MEMS microphone 120 shown in FIG. 2 after being cut along a line A-A in a fifth embodiment.

The MEMS microphone 120 described in this embodiment is different from the MEMS microphone 120 described in the third embodiment in that an active layer 42 and a chip body 41 are sequentially stacked on a surface of a connecting layer 60 facing away from a support frame 32. For example, the connecting layer 60 is a solder layer 62. In some other embodiments, the connecting layer 60 may alternatively be a wafer bonding layer 61, an anisotropic conductive film (Anisotropic Conductive Film, ACF) 63, or the like.

In this embodiment, a first solder portion 621, a second solder portion 622, and a third solder portion 623 of the solder layer 62 are all arranged between the side surface of the MEMS chip 30 and a surface of the active layer 42 facing away from the chip body 41, and are arranged at intervals from each other. A solder resist is coated between the first solder portion 621 and the second solder portion 622, to prevent the first solder portion 621 and the second solder portion 622 from coming into contact with each other, so that a short circuit between the MEMS chip 30 and the ASIC chip 40 can be avoided.

Specifically, the first solder portion 621 is electrically connected between a first wiring layer 33 and the active layer 42. The second solder portion 622 is electrically connected between a second wiring layer 36 and the active layer 42. The third solder portion 623 is electrically connected between a third wiring layer 37 and the active layer 42. For example, there are two third solder portions 623. Each third solder portion 623 is electrically connected between a third wiring layer 37 and the active layer 42. In addition, a solder resist is also coated between the two third solder portions 623, to avoid a short circuit caused by contact between two adjacent third solder portions 623.

In this embodiment, a flip chip manner is used, so that the active layer 42 of the ASIC chip 40 can be electrically connected to the MEMS chip 30 through the solder layer 62. In this case, there is no need to additionally arrange a wire inside the ASIC chip 40, which can simplify a production process of the MEMS microphone 120, and helps improve production efficiency of the MEMS microphone 120.

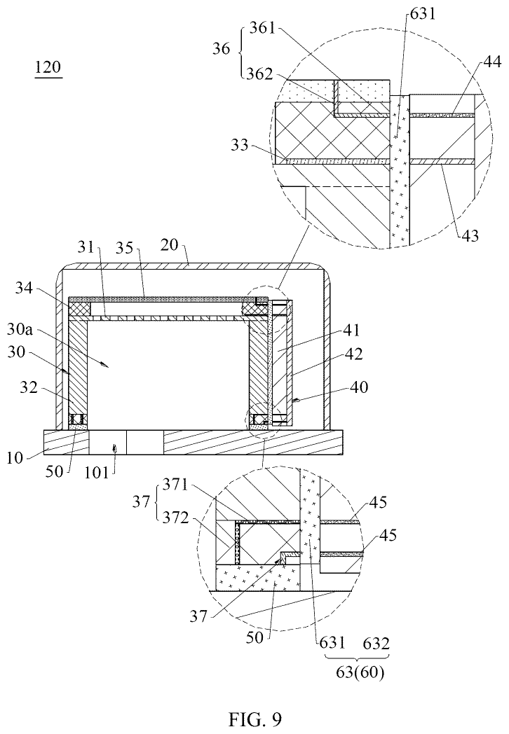

Refer to FIG. 9. FIG. 9 is a schematic diagram of a structure of the MEMS microphone 120 shown in FIG. 2 after being cut along a line A-A in a sixth embodiment.

The MEMS microphone 120 described in this embodiment is different from the MEMS microphone 120 described in the third embodiment in that a connecting layer 60 is an anisotropic conductive film (Anisotropic Conductive Film, ACF) 63. The anisotropic conductive film 63 includes a first conductive part 631 and a second conductive part 632. The first conductive part 631 is electrically connected between a first wiring layer 33, a second wiring layer 36, and an active layer 42. The second conductive part 632 is located on a side of the first conductive part 631 facing a circuit board 10, and is electrically connected between a third wiring layer 37 and the active layer 42. For example, the second conductive part 632 is fixedly connected to the first conductive part 631. In some other embodiments, the second conductive part 632 may alternatively be spaced apart from the first conductive part 631.

It may be understood that, the anisotropic conductive film 63 has a conductive particle inside, and the conductive particle can transmit an electrical signal of a capacitance change between a back plate 31 and a diaphragm 35 to the ASIC chip 40, so that the MEMS chip 30 is electrically connected to the ASIC chip 40. It should be noted that, the conductive particle in the anisotropic conductive film 63 moves only in a thickness direction of the inside of the anisotropic conductive film 63, to ensure that the anisotropic conductive film 63 can conduct electricity only in the thickness direction. In this way, it can be ensured that a circuit formed between the first wiring layer 33 and the active layer 42 and a circuit formed between the second wiring layer 36 and the active layer 42 are not interleaved, thereby avoiding a short circuit between the MEMS chip 30 and the ASIC chip 40.

In addition, a fixing member 50 of the MEMS microphone 120 is also an anisotropic conductive film, so that the MEMS chip 30 is electrically connected to the circuit board 10 through the ASIC chip 40. In this arrangement, the anisotropic conductive film 63 is directly attached between the MEMS chip 30 and the ASIC chip 40 and between the MEMS chip 30 and the circuit board 10, so that the MEMS chip 30 can be electrically connected to the ASIC chip 40, and the ASIC chip can be electrically connected to the circuit board 10. In this way, the operation is simple, which helps improve production efficiency of the MEMS microphone 120.

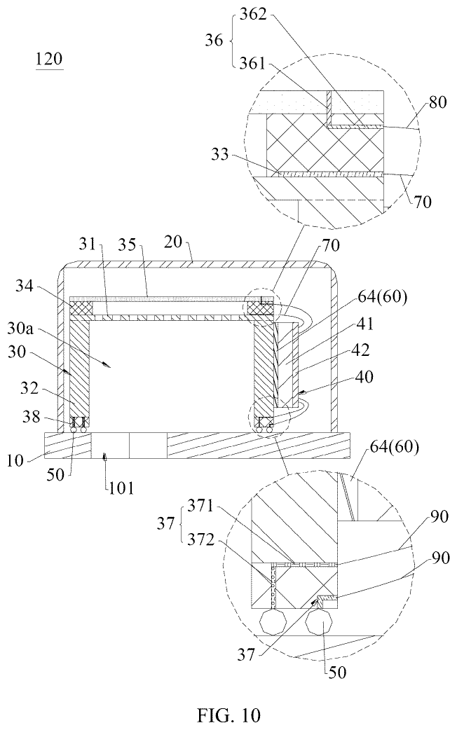

Refer to FIG. 10. FIG. 10 is a schematic diagram of a structure of the MEMS microphone 120 shown in FIG. 2 after being cut along a line A-A in a seventh embodiment.

The MEMS microphone 120 described in this embodiment is different from the MEMS microphone 120 described in the third embodiment in that a connecting layer 60 is a die attach film (Die Attach Film, DAF) 64. The die attach film 64 is attached between a support frame 32 of the MEMS chip 30 and a chip body 41, so that the MEMS chip 30 is fixedly connected to the ASIC chip 40.

In this embodiment, both the electrical connection between the MEMS chip 30 and the ASIC chip 40 and the electrical connection between the ASIC chip 40 and a circuit board 10 are implemented through wire bonding. Specifically, the MEMS microphone 120 further includes a first wire 70, a second wire 80, and a third wire 90. The first wire 70 is electrically connected between a first wiring layer 33 and an active layer 42, so that a back plate 31 is electrically connected to the ASIC chip 40. The second wire 80 is electrically connected between a second wiring layer 36 and the active layer 42, so that a diaphragm 35 is electrically connected to the ASIC chip 40. The third wire 90 is electrically connected between a third wiring layer 37 and the active layer 42, so that the ASIC chip 40 is electrically connected to the circuit board 10, so that the MEMS chip 30 is electrically connected to the circuit board 10 through the ASIC chip 40. For example, there are two third wires 90. Each third wire 90 is electrically connected between a first third wiring layer 37 and the active layer 42.

In this arrangement, the electrical connection between the MEMS chip 30 and the ASIC chip 40 and the electrical connection between the ASIC chip 40 and the circuit board 10 are implemented through wire bonding, so that reliability of the connection between the produced MEMS chip 30 and the ASIC chip 40 is relatively good. In addition, costs of the wire bonding process are lower than those of the wafer bonding process, which also helps reduce production costs of the MEMS microphone 120. In addition, there is no need to additionally arrange a wiring layer inside the ASIC chip 40, which helps simplify a production process of the MEMS microphone 120 and improve production efficiency of the MEMS microphone 120.

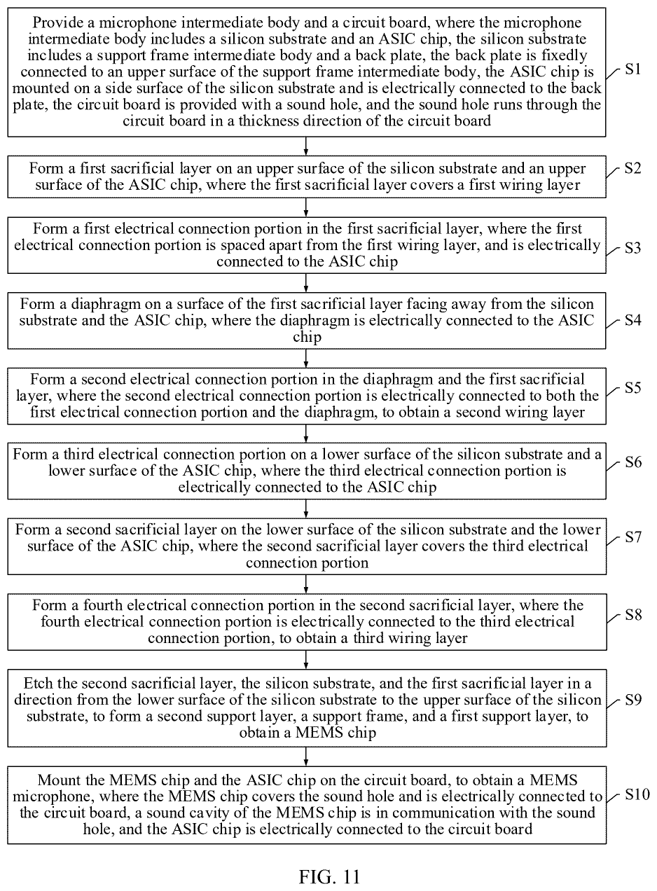

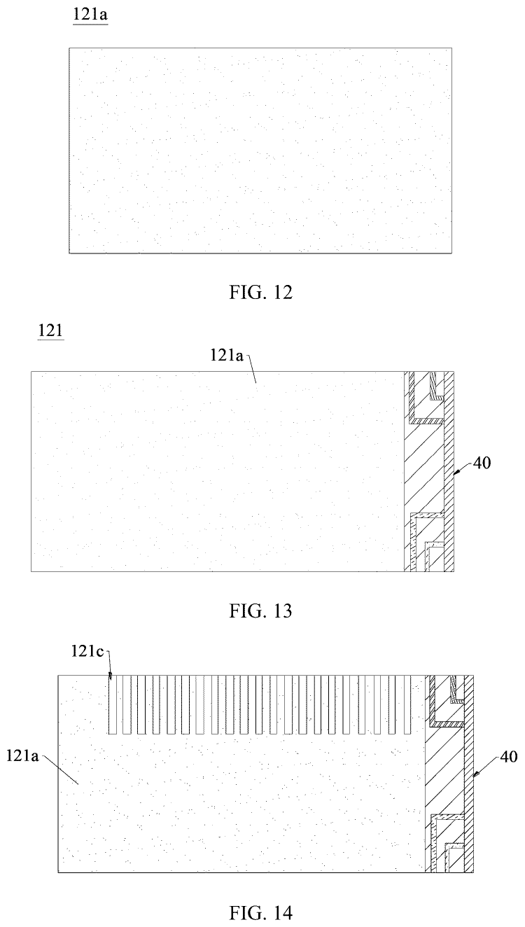

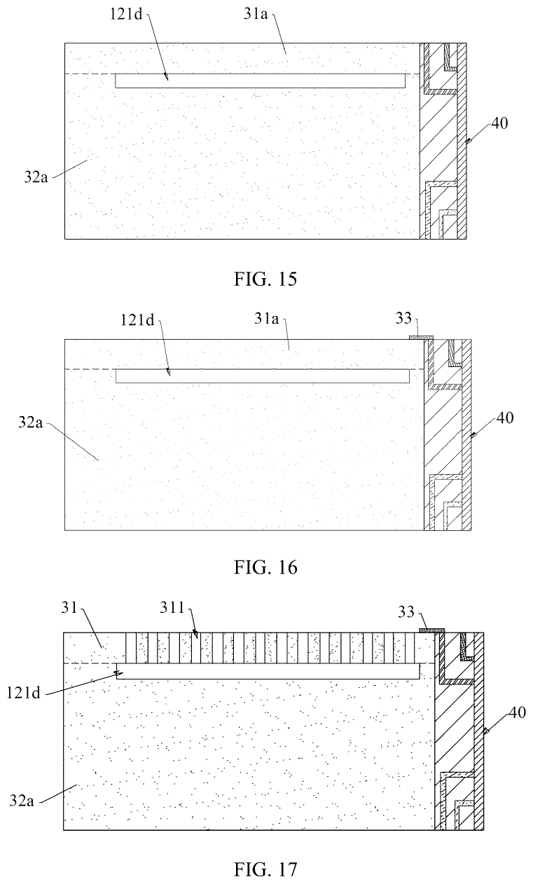

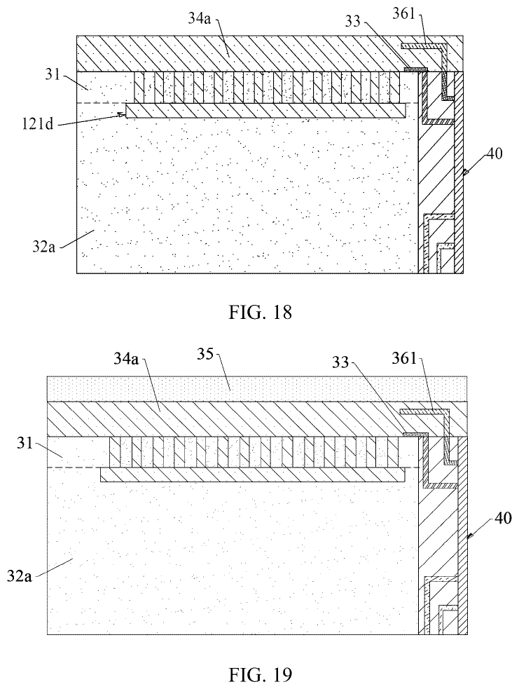

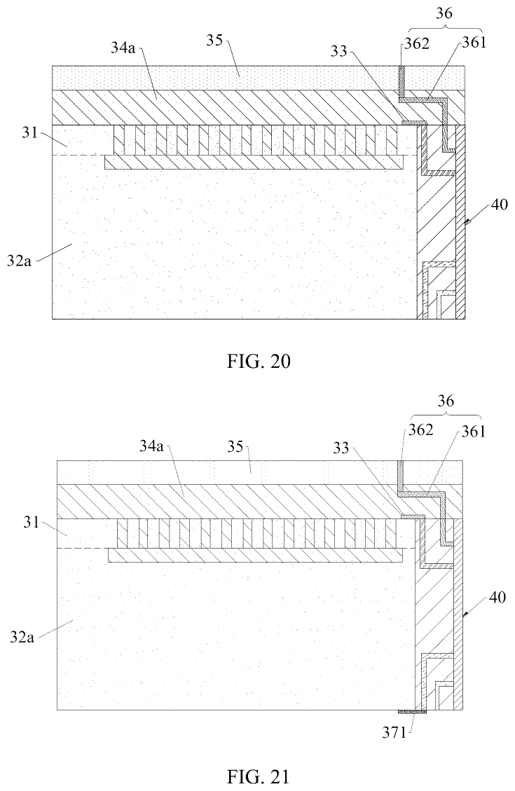

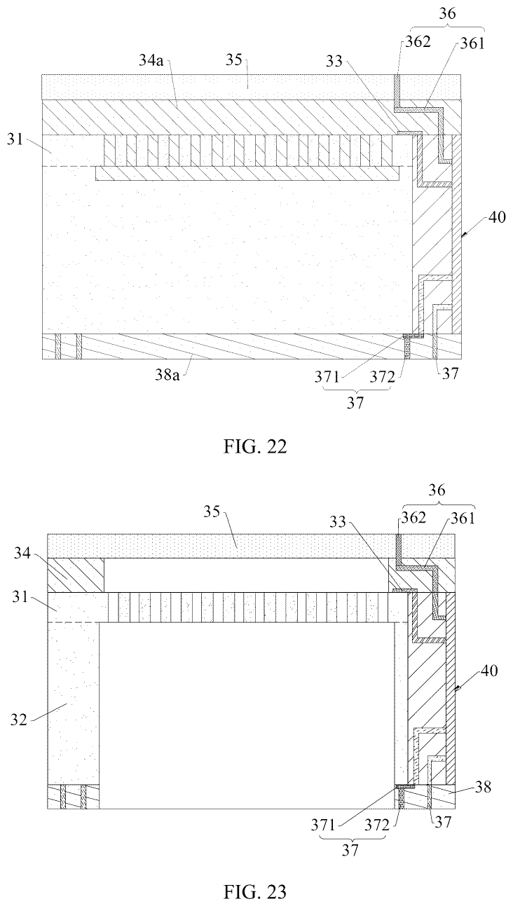

Refer to FIG. 11 to FIG. 23 together. This application further provides a first method for preparing a MEMS microphone 120, to prepare the MEMS microphone 120 in the first embodiment.

Step S1: Provide a microphone intermediate body 121 and a circuit board, where the microphone intermediate body 121 includes a silicon substrate 121a and an ASIC chip 40, the silicon substrate 121a includes a support frame intermediate body 32a and a back plate 31, the back plate 31 is fixedly connected to an upper surface of the support frame intermediate body 32a, the ASIC chip 40 is mounted on a side surface of the silicon substrate 121a and is electrically connected to the back plate 31, the circuit board is provided with a sound hole, and the sound hole runs through the circuit board in a thickness direction of the circuit board.

In this embodiment, Step S1 may be completed through Step S11 to Step S15.

Step S11: Mount the ASIC chip 40 on the side surface of the silicon substrate 121a, to obtain a microphone prefabricated body (not marked in the figure). For example, the ASIC chip 40 may be mounted on the side surface of the silicon substrate 121a by using a wafer bonding process. Planarization may be performed on a surface of the silicon substrate 121a and a surface of the ASIC chip 40 by using a polishing process such as a chemical mechanical polishing (Chemical Mechanical Polishing, CMP) process, to ensure good flatness of the connected surfaces of the silicon substrate 121a and the ASIC chip 40.

Step S12: Etch the silicon substrate 121a to form a plurality of etched grooves 121c.

The plurality of etched grooves 121c are arranged at intervals from each other. Openings of the plurality of etched grooves 121c are all located on an upper surface of the silicon substrate 121a. The plurality of etched grooves 121c are all recessed in a direction from the upper surface of the silicon substrate 121a to a lower surface of the silicon substrate 121a. A distance between centers of openings of two adjacent etched grooves 121c ranges from 0.1 μm to 1 μm. A width of an opening of each etched groove 121c ranges from 0.1 μm to 1 μm. A depth of each etched groove 121c ranges from 1 μm to 10 μm.

Step S13: Anneal the microphone prefabricated body to form a cavity 121d inside the silicon substrate 121a, to obtain a back plate intermediate body 31a and the support frame intermediate body 32a. The back plate intermediate body 31a is fixedly connected to the upper surface of the support frame intermediate body 32a. A thickness of the back plate intermediate body 31a ranges from 1 μm to 3 μm, to ensure that structural strength of the back plate 31 formed in subsequent steps is large, thereby meeting production requirements of a product. It should be noted that, if a thickness of the back plate 31 required to be formed in the subsequent steps is greater than 3 μm, an epitaxy process may be applied to the upper surface of the silicon substrate 121a, to increase the thickness of the back plate intermediate body 31a.

In Step S13, the microphone prefabricated body may be annealed by using a VENSEN (VENSEN) process. Reaction atmosphere used in the VENSEN process is hydrogen, and a process temperature used in the VENSEN process ranges from 1000 °C to 1200 °C. In this process, silicon atoms diffuse, are filled in the plurality of etched grooves 121c, and close the openings of the plurality of etched grooves 121c, to form the cavity 121d inside the silicon substrate 121a.

Step S14: Form a first wiring layer 33 on an upper surface of the back plate intermediate body 31a and an upper surface of the ASIC chip 40. The first wiring layer 33 is electrically connected between the back plate intermediate body 31a and the ASIC chip 40. For example, the first wiring layer 33 may be formed on the upper surface of the back plate intermediate body 31a and the upper surface of the ASIC chip 40 by using a Damascene process.

In Step S15, a photoresist may be first coated on the upper surface of the back plate intermediate body 31a and the upper surface of the ASIC chip 40, then a region of the to-be-manufactured first wiring layer 33 is formed by using processes such as exposure, development, and photolithography, then the first wiring layer 33 is formed in the region of the to-be-manufactured first wiring layer 33 through electroplating, and finally the photoresist is removed to form the patterned first wiring layer 33.

Step S15: Etch the back plate intermediate body 31a to form a plurality of through holes 311, to obtain the back plate 31. The plurality of through holes 311 are arranged at intervals, all run through the back plate 31 in a thickness direction of the back plate 31, and are all in communication with the cavity 121d.

In Step S15, the first wiring layer 33 is arranged on an upper surface of the back plate 31 and the upper surface of the ASIC chip 40. The first wiring layer 33 is electrically connected between the back plate 31 and the ASIC chip 40.

Step S2: Form a first sacrificial layer 34a on the upper surface of the silicon substrate 121a and the upper surface of the ASIC chip 40, where the first sacrificial layer 34a covers the first wiring layer 33. For example, the first sacrificial layer 34a may be formed on the upper surface of the silicon substrate 121a and the upper surface of the ASIC chip 40 by using a vapor deposition method. In some other embodiments, the first sacrificial layer 34a may alternatively be formed on the upper surface of the silicon substrate 121a and the upper surface of the ASIC chip 40 by using a thermal oxidation method.

In Step S2, one part of the first sacrificial layer 34a is filled in the cavity 121d and the plurality of through holes 311, and the other part of the first sacrificial layer 34a is arranged on the upper surface of the back plate 31 and the upper surface of the ASIC chip 40. A thickness of the part of the first sacrificial layer 34a arranged on the upper surface of the back plate 31 and the upper surface of the ASIC chip 40 ranges from 1 μm to 4 μm.

Step S3: Form a first electrical connection portion 361 in the first sacrificial layer 34a, where the first electrical connection portion 361 is spaced apart from the first wiring layer 33, and is electrically connected to the ASIC chip 40. For example, the first electrical connection portion 361 may be formed in the first sacrificial layer 34a by using the Damascene process.

Step S4: Form a diaphragm 35 on a surface of the first sacrificial layer 34a facing away from the silicon substrate 121a and the ASIC chip 40, where the diaphragm 35 is electrically connected to the ASIC chip 40.

Step S5: Form a second electrical connection portion 362 in the diaphragm 35 and the first sacrificial layer 34a, where the second electrical connection portion 362 is electrically connected to both the first electrical connection portion 361 and the diaphragm 35, to obtain a second wiring layer 36. The second wiring layer 36 is electrically connected between the diaphragm 35 and the ASIC chip 40. For example, the second electrical connection portion 362 may be formed in the diaphragm 35 and the first sacrificial layer 34a by using a through-silicon-via (Through-Silicon-Via, TSV) technology. The second electrical connection portion 362 may be made of copper, tungsten, polysilicon, or the like.

Step S6: Form a third electrical connection portion 371 on the lower surface of the silicon substrate 121a and a lower surface of the ASIC chip 40, where the third electrical connection portion 371 is electrically connected to the ASIC chip 40. For example, the third electrical connection portion 371 may be formed on the lower surface of the silicon substrate 121a and the lower surface of the ASIC chip 40 by using the Damascene process.

In Step S6, a photoresist may be first coated on the lower surface of the silicon substrate 121a and the lower surface of the ASIC chip 40, then a region of the to-be-manufactured third electrical connection portion 371 is formed by using processes such as exposure, development, and photolithography, then the third electrical connection portion 371 is formed in the region of the to-be-manufactured third electrical connection portion 371 through electroplating, and finally the photoresist is removed to form the patterned third electrical connection portion 371.

Step S7: Form a second sacrificial layer 38a on the lower surface of the silicon substrate 121a and the lower surface of the ASIC chip 40, where the second sacrificial layer 38a covers the third electrical connection portion 371.

Step S8: Form a fourth electrical connection portion 372 in the second sacrificial layer 38a, where the fourth electrical connection portion 372 is electrically connected to the third electrical connection portion 371, to obtain a third wiring layer 37. The third wiring layer 37 is electrically connected to the ASIC chip 40. For example, the fourth electrical connection portion 372 may be formed in the second sacrificial layer 38a by using the through-silicon-via technology.

Step S9: Etch the second sacrificial layer 38a, the silicon substrate 121a, and the first sacrificial layer 34a in a direction from the lower surface of the silicon substrate 121a to the upper surface of the silicon substrate 121a, to form a second support layer 38, a support frame 32, and a first support layer 34, to obtain a MEMS chip 30. In Step S9, the silicon substrate 121a is etched and polished, to form a sound cavity 30a of the MEMS chip 30.

Step S10: Mount the MEMS chip 30 and the ASIC chip 40 on the circuit board, to obtain the MEMS microphone 120, where the MEMS chip 30 covers the sound hole and is electrically connected to the circuit board, the sound cavity 30a of the MEMS chip 30 is in communication with the sound hole, and the ASIC chip 40 is electrically connected to the circuit board. Step S10 further includes: fixedly mounting a housing on the circuit board, and enabling the housing to cover the MEMS chip 30 and the ASIC chip 40.

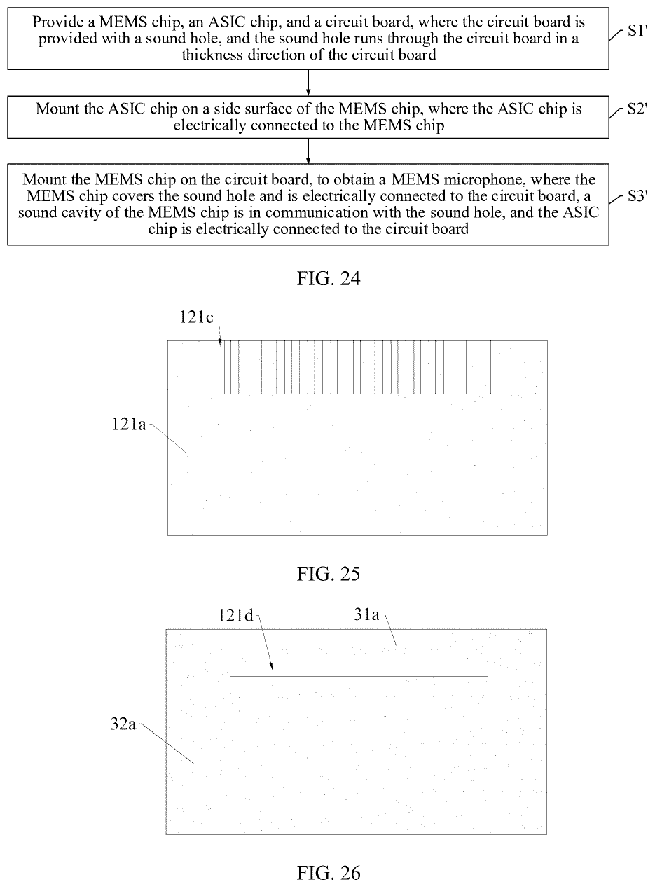

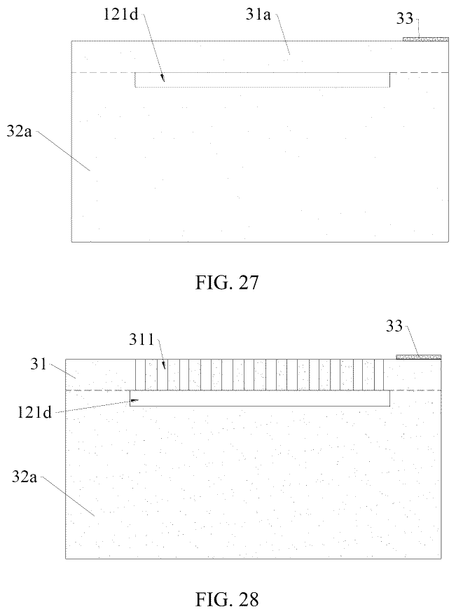

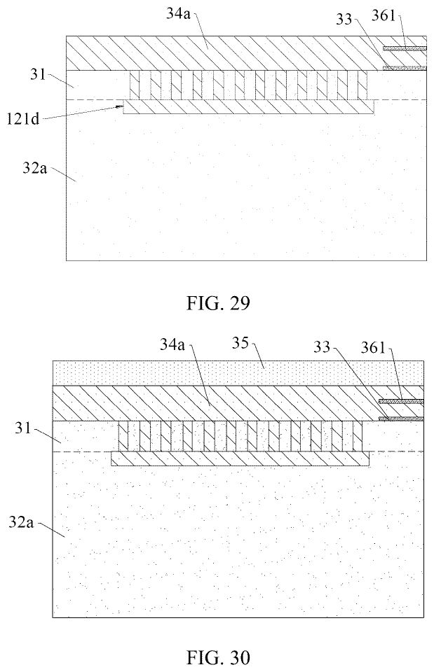

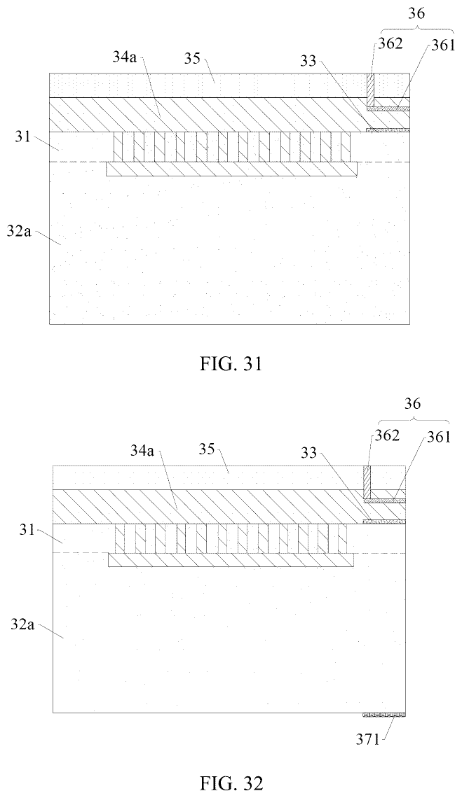

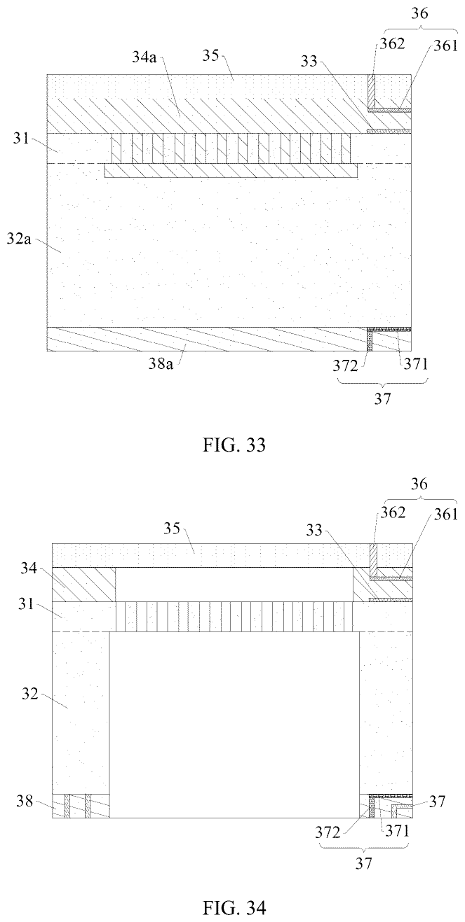

Refer to FIG. 24 to FIG. 34 together. This application further provides a second method for preparing a MEMS microphone 120, to prepare the MEMS microphone 120 in the second embodiment.

Step S1′: Provide a MEMS chip 30, an ASIC chip, and a circuit board, where the circuit board is provided with a sound hole, and the sound hole runs through the circuit board in a thickness direction of the circuit board. The MEMS chip 30 includes a back plate 31, a support frame 32, a first support layer 34, a diaphragm 35, a first wiring layer 33, a second wiring layer 36, and a third wiring layer 37. The back plate 31 is fixedly connected to a side of the support frame 32 facing away from the circuit board. The first support layer 34 is arranged on a surface of the back plate 31 facing away from the support frame 32. The diaphragm 35 is arranged on a surface of the first support layer 34 facing away from the back plate 31. Both the first wiring layer 33 and the second wiring layer 36 are arranged on a side of the back plate 31 facing away from the support frame 32. The second wiring layer 36 is spaced apart from the first wiring layer 33. The third wiring layer 37 is arranged on a side of the support frame 32 facing the circuit board. The ASIC chip includes a chip body and an active layer, where the active layer and the chip body are stacked.

Step S1′ further includes Step S101′ to Step S112′.

Step S101′: Etch a silicon substrate 121a to form a plurality of etched grooves 121c. The plurality of etched grooves 121c are arranged at intervals from each other. Openings of the plurality of etched grooves 121c are all located on an upper surface of the silicon substrate 121a. The plurality of etched grooves 121c are all recessed in a direction from the upper surface of the silicon substrate 121a to a lower surface of the silicon substrate 121a.

Step S102′: Anneal the silicon substrate 121a to form a cavity 121d inside the silicon substrate 121a, to obtain a back plate intermediate body 31a and a support frame intermediate body 32a. The back plate intermediate body 31a is fixedly connected to the upper surface of the support frame intermediate body 32a.

Step S103′: Form the first wiring layer 33 on an upper surface of the back plate intermediate body 31a.

In some other implementations, in Step S103′, the first wiring layer 33 may alternatively be formed in the back plate intermediate body 31a. An end of the first wiring layer 33 away from the back plate 31 is exposed relative to a peripheral surface of a first sacrificial layer 34a.

Step S104′: Etch the back plate intermediate body 31a to form a plurality of through holes 311, to obtain the back plate 31. The plurality of through holes 311 are arranged at intervals, all run through the back plate 31 in a thickness direction of the back plate 31, and are all in communication with the cavity 121d.

In Step S104′, the first wiring layer 33 is arranged on an upper surface of the back plate 31. The first wiring layer 33 is electrically connected to the back plate 31.

Step S105′: Form the first sacrificial layer 34a on the upper surface of the silicon substrate 121a, where the first sacrificial layer 34a covers the first wiring layer 33.

In Step S105′, one part of the first sacrificial layer 34a is filled in the cavity 121d and the plurality of through holes 311, and the other part of the first sacrificial layer 34a is arranged on the upper surface of the back plate 31.

Step S106′: Form a first electrical connection portion 361 in the first sacrificial layer 34a, where the first electrical connection portion 361 is spaced apart from the first wiring layer 33.

Step S107′: Form the diaphragm 35 on a surface of the first sacrificial layer 34a facing away from the silicon substrate 121a.

Step S108′: Form a second electrical connection portion 362 in the diaphragm 35 and the first sacrificial layer 34a, where the second electrical connection portion 362 is electrically connected to both the first electrical connection portion 361 and the diaphragm 35, to obtain the second wiring layer 36. The second wiring layer 36 is electrically connected to the diaphragm 35.

Step S109′: Form a third electrical connection portion 371 on the lower surface of the silicon substrate 121a.

Step S110′: Form a second sacrificial layer 38a on the lower surface of the silicon substrate 121a, where the second sacrificial layer 38a covers the third electrical connection portion 371.

Step S111′: Form a fourth electrical connection portion 372 in the second sacrificial layer 38a, where the fourth electrical connection portion 372 is electrically connected to the third electrical connection portion 371, to obtain the third wiring layer 37.

Step S112′: Etch the second sacrificial layer 38a, the silicon substrate 121a, and the first sacrificial layer 34a in a direction from the lower surface of the silicon substrate 121a to the upper surface of the silicon substrate 121a, to form a second support layer 38, the support frame 32, and the first support layer 34, to obtain the MEMS chip 30.

Step S2′: Mount the ASIC chip 40 on a side surface of the MEMS chip 30, where the ASIC chip 40 is electrically connected to the MEMS chip 30.

Step S2′ may be completed through a plurality of different implementations. For example, in a first implementation, wafer bonding is performed on a surface of the chip body facing away from the active layer and the side surface of the MEMS chip 30, to form a connecting layer. In a second implementation, soldering is performed on a surface of the chip body facing away from the active layer and the side surface of the MEMS chip 30, to form a first solder portion, a second solder portion, and a third solder portion, to obtain a connecting layer.

In a third implementation, Step S2′ may be completed through the following Step S21′ to Step S23′.

Step S21′: Provide an anisotropic conductive film.

Step S22′: Fixedly mount the anisotropic conductive film on the side surface of the MEMS chip 30.

Step S23′: Mount the ASIC chip on a surface of the anisotropic conductive film facing away from the MEMS chip 30.

In the third implementation, Step S2′ may be completed through the following Step S21″ to Step S26″.

Step S21″: Provide a die attach film, a first wire, a second wire, and a third wire.

Step S22″: Fixedly mount the die attach film on an outer peripheral surface of the support frame 32.

Step S23″: Mount the ASIC chip on a surface of the die attach film facing away from the support frame 32, where the chip body and the active layer are sequentially stacked on the surface of the die attach film facing away from the support frame 32.

Step S24″: Electrically connect the first wire between the first wiring layer 33 and the active layer.

Step S25″: Electrically connect the second wire between the second wiring layer 36 and the active layer.

Step S26″: Electrically connect the third wire between the third wiring layer 37 and the active layer.

Step S3′: Mount the MEMS chip 30 on the circuit board, to obtain the MEMS microphone 120, where the MEMS chip 30 covers the sound hole and is electrically connected to the circuit board, a sound cavity 30a of the MEMS chip 30 is in communication with the sound hole, and the ASIC chip is electrically connected to the circuit board. Step S3′ further includes: fixedly mounting a housing on the circuit board, and enabling the housing to cover the MEMS chip 30 and the ASIC chip 40.

The foregoing descriptions are merely a part of embodiments and implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A MEMS microphone, comprising a circuit board, a MEMS chip, and an ASIC chip, wherein the circuit board is provided with a sound hole, the sound hole runs through the circuit board in a thickness direction of the circuit board, the MEMS chip is mounted on the circuit board, covers the sound hole, and is electrically connected to the circuit board, a sound cavity of the MEMS chip is in communication with the sound hole, the MEMS chip comprises a back plate, a support frame, a first support layer, a diaphragm, and a second support layer, wherein the back plate is fixedly connected to a side of the support frame facing away from the circuit board, the first support layer is arranged on a surface of the back plate facing away from the support frame, the diaphragm is arranged on a surface of the first support layer facing away from the back plate, and the second support layer is arranged on a surface of the support frame facing away from the back plate; and the first support layer is further arranged on a surface of the ASIC chip facing away from the circuit board, and the diaphragm is further arranged on a surface of the first support layer facing away from the ASIC chip; and the ASIC chip is mounted on a side surface of the MEMS chip and is electrically connected to both the MEMS chip and the circuit board; and
an orthographic projection of the diaphragm on the back plate covers at least a part of the surface of the ASIC chip facing away from the circuit board.

2. The MEMS microphone according to claim 1, wherein the ASIC chip comprises a chip body and an active layer, wherein the active layer and the chip body are stacked on the side surface of the MEMS chip.

3.-4. (canceled)

5. The MEMS microphone according to claim 2, wherein the MEMS chip further comprises a first wiring layer, a second wiring layer, and a third wiring layer, wherein both the first wiring layer and the second wiring layer are arranged on a side of the back plate facing away from the support frame, the first wiring layer is electrically connected between the back plate and the ASIC chip, the second wiring layer is spaced apart from the first wiring layer and is electrically connected between the diaphragm and the ASIC chip, and the third wiring layer is arranged on a side of the support frame facing the circuit board and is electrically connected between the ASIC chip and the circuit board.

6. The MEMS microphone according to claim 5, wherein the MEMS microphone further comprises a connecting layer, wherein the connecting layer is connected between the outer peripheral surface of the support frame and the ASIC chip.

7. The MEMS microphone according to claim 6, wherein the connecting layer is a wafer bonding layer, and is electrically connected to the first wiring layer, the second wiring layer, the third wiring layer, and the active layer.

8. The MEMS microphone according to claim 6, wherein the connecting layer is a solder layer, the connecting layer comprises a first solder portion, a second solder portion, and a third solder portion, the first solder portion is electrically connected between the first wiring layer and the active layer, the second solder portion is spaced apart from the first solder portion and is electrically connected between the second wiring layer and the active layer, and the third solder portion is located on a side of the first solder portion and the second solder portion facing the circuit board, is spaced apart from both the first solder portion and the second solder portion, and is electrically connected between the third wiring layer and the active layer.

9. The MEMS microphone according to claim 6, wherein the connecting layer is an anisotropic conductive film, wherein the anisotropic conductive film comprises a first conductive part and a second conductive part, the first conductive part is electrically connected between the first wiring layer, the second wiring layer, and the active layer, the second conductive part is located on a side of the first conductive part facing the circuit board, and the second conductive part is electrically connected between the third wiring layer and the active layer.

10. The MEMS microphone according to claim 6, wherein the chip body and the active layer are sequentially stacked on a surface of the connecting layer facing away from the support frame.

11. The MEMS microphone according to claim 10, wherein the ASIC chip further comprises a fourth wiring layer, a fifth wiring layer, and a sixth wiring layer, wherein the fourth wiring layer is electrically connected between the active layer and the first wiring layer, the fifth wiring layer is spaced apart from the fourth wiring layer and is electrically connected between the active layer and the second wiring layer, and the sixth wiring layer is located on a side of the fourth wiring layer and the fifth wiring layer facing the circuit board, is spaced apart from both the fourth wiring layer and the fifth wiring layer, and is electrically connected between the active layer and the third wiring layer.

12. The MEMS microphone according to claim 10, wherein the connecting layer is a die attach film, wherein the die attach film is attached between the support frame and the chip body; and
the MEMS microphone further comprises a first wire, a second wire, and a third wire, wherein the first wire is electrically connected between the first wiring layer and the active layer, the second wire is electrically connected between the second wiring layer and the active layer, and the third wire is electrically connected between the third wiring layer and the active layer.

13. The MEMS microphone according to claim 6, wherein the active layer and the chip body are sequentially stacked on a surface of the connecting layer facing away from the support frame.

14. The MEMS microphone according to claim 1, wherein the back plate is provided with a plurality of through holes, wherein the plurality of through holes run through the back plate in a thickness direction of the back plate, are arranged at intervals from each other, and are all in communication with the sound cavity of the MEMS.

15. The MEMS microphone according to claim 1, wherein the MEMS microphone further comprises a housing, wherein the housing is fixedly mounted on the circuit board, and covers the MEMS chip and the ASIC chip.

16. An electronic device, comprising a processor and the MEMS microphone according to claim 1, wherein the processor is electrically connected to the MEMS microphone.

17. A method for preparing a MEMS microphone, comprising:
providing a microphone intermediate body and a circuit board, wherein the microphone intermediate body comprises a silicon substrate and an ASIC chip, the silicon substrate comprises a support frame intermediate body and a back plate, the back plate is fixedly connected to an upper surface of the support frame intermediate body, the ASIC chip is mounted on a side surface of the silicon substrate and is electrically connected to the back plate, the circuit board is provided with a sound hole, and the sound hole runs through the circuit board in a thickness direction of the circuit board;
forming a first sacrificial layer on an upper surface of the silicon substrate and an upper surface of the ASIC chip;
forming a diaphragm on a surface of the first sacrificial layer facing away from the silicon substrate and the ASIC chip, wherein the diaphragm is electrically connected to the ASIC chip, an orthographic projection of the diaphragm on the back plate covers at least a part of the surface of the ASIC chip facing away from the circuit board;
forming a second sacrificial layer on a lower surface of the silicon substrate and a lower surface of the ASIC chip;
etching the second sacrificial layer, the silicon substrate, and the first sacrificial layer in a direction from the lower surface of the silicon substrate to the upper surface of the silicon substrate, to form a second support layer, a support frame, and a first support layer, to obtain a MEMS chip; and
mounting the MEMS chip and the ASIC chip on the circuit board, to obtain a MEMS microphone, wherein the MEMS chip covers the sound hole and is electrically connected to the circuit board, a sound cavity of the MEMS chip is in communication with the sound hole, and the ASIC chip is electrically connected to the circuit board.

18. The method for preparing a MEMS microphone according to claim 17, wherein the step of providing a microphone intermediate body and a circuit board comprises:
forming a first wiring layer on an upper surface of the back plate and the upper surface of the ASIC chip, wherein the first wiring layer is electrically connected between the back plate and the ASIC chip; and
in the step of forming a first sacrificial layer on an upper surface of the silicon substrate and an upper surface of the ASIC chip, the first sacrificial layer covers the first wiring layer.

19. The method for preparing a MEMS microphone according to claim 18, wherein after the step of forming a first sacrificial layer on an upper surface of the silicon substrate and an upper surface of the ASIC chip, and before the step of forming a diaphragm on a surface of the first sacrificial layer facing away from the silicon substrate and the ASIC chip, the method for preparing a MEMS microphone further comprises:
forming a first electrical connection portion in the first sacrificial layer, wherein the first electrical connection portion is spaced apart from the first wiring layer, and is electrically connected to the ASIC chip; and
after the step of forming a diaphragm on a surface of the first sacrificial layer facing away from the silicon substrate and the ASIC chip, and before the step of forming a second sacrificial layer on a lower surface of the silicon substrate and a lower surface of the ASIC chip, the method for preparing a MEMS microphone further comprises:
forming a second electrical connection portion in the diaphragm and the first sacrificial layer, wherein the second electrical connection portion is electrically connected to both the first electrical connection portion and the diaphragm, to obtain a second wiring layer, wherein the second wiring layer is electrically connected between the diaphragm and the ASIC chip.

20. The method for preparing a MEMS microphone according to claim 17, wherein after the step of forming a diaphragm on a surface of the first sacrificial layer facing away from the silicon substrate and the ASIC chip, and before the step of forming a second sacrificial layer on a lower surface of the silicon substrate and a lower surface of the ASIC chip, the method for preparing a MEMS microphone further comprises:
forming a third electrical connection portion on the lower surface of the silicon substrate and the lower surface of the ASIC chip, wherein the third electrical connection portion is electrically connected to the ASIC chip;
in the step of forming a second sacrificial layer on a lower surface of the silicon substrate and a lower surface of the ASIC chip, the second sacrificial layer covers the third electrical connection portion; and
after the step of forming a second sacrificial layer on a lower surface of the silicon substrate and a lower surface of the ASIC chip, and before the step of etching the second sacrificial layer, the silicon substrate, and the first sacrificial layer in a direction from the lower surface of the silicon substrate to the upper surface of the silicon substrate, the method for preparing a MEMS microphone further comprises:
forming a fourth electrical connection portion in the second sacrificial layer, wherein the fourth electrical connection portion is electrically connected to the third electrical connection portion, to obtain a third wiring layer, wherein the third wiring layer is electrically connected to the ASIC chip.

21. The method for preparing a MEMS microphone according to claim 17, wherein the step of providing a microphone intermediate body and a circuit board comprises:
mounting the ASIC chip on the side surface of the silicon substrate, to obtain a microphone prefabricated body;
etching the silicon substrate to form a plurality of etched grooves, wherein the plurality of etched grooves are arranged at intervals from each other, and openings of the plurality of etched grooves are all located on the upper surface of the silicon substrate;
annealing the microphone prefabricated body to form a cavity inside the silicon substrate, to obtain a back plate intermediate body and the support frame intermediate body, wherein the back plate intermediate body is fixedly connected to the upper surface of the support frame intermediate body; and
etching the back plate intermediate body to form a plurality of through holes, to obtain the back plate, wherein the plurality of through holes are arranged at intervals, all run through the back plate in a thickness direction of the back plate, and are all in communication with the cavity.

22. The method for preparing a MEMS microphone according to claim 17, wherein the step of mounting the MEMS chip and the ASIC chip on the circuit board, to obtain a MEMS microphone comprises:
fixedly mounting a housing on the circuit board, and enabling the housing to cover the MEMS chip and the ASIC chip.

23.-27. (canceled)
